(19) United States
(12) Patent Application Publication
(10) Pub. No.: US 2010/0271706 A1
(43) Pub. Date: Oct. 28, 2010

(54) OPTICAL MEMBER AND OPTICAL SYSTEM, OPTICAL UNIT AND OPTICAL DEVICE INCLUDING THE OPTICAL MEMBER

(75) Inventors: Kazuhiro Yamada, Kadoma-shi (JP); Yasuhiro Tanaka, Kadoma-shi (JP); Michihiro Yamagata, Kadoma-shi (JP); Makoto Umetani, Kadoma-shi (JP); Takamasa Tamura, Kadoma-shi (JP); Motonobu Yoshikawa, Kadoma-shi (JP); Hiroshi Yamaguchi, Kadoma-shi (JP); Masaaki Sunohara, Kadoma-shi (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(73) Assignee: PANASONIC CORPORATION, Kadoma-shi, Osaka (JP)

(21) Appl. No.: 12/305,871

(22) PCT Filed: Jun. 20, 2007
(86) PCT No.: PCT/JP2007/062407

§ 371 Date: Jul. 14, 2010

(30) Foreign Application Priority Data
Jun. 21, 2006 (JP) 2006-171540

(51) Int. Cl. G02B 1/11

(52) U.S. Cl. 359/614

(57) ABSTRACT

The present disclosure relates to an optical member in which an antireflection concave-convex structure for suppressing reflection of light is provided on its surface, and an optical system, an optical unit and an optical device each including the optical member.

The present disclosure provides an optical member in which the generation of reflection light and diffraction light is sufficiently suppressed and which can be fabricated in a simple manner.

A antireflection concave-convex structure (15) for suppressing reflection of light, formed of filiform convex portions (16) regularly arranged, is provided on an interior surface (1a) of a lens tube (1). The antireflection concave-convex structure (15) is configured so that an angle between a normal vector of an incident plane of the light whose reflection is to be suppressed and a vector connecting respective apexes of adjacent two of the structure units at the incident surface is 60 degrees or less.

### TECHNICAL FIELD

The present disclosure relates to an optical member and an optical system, an optical unit and an optical device including the optical member and, more particularly relates to an optical member in which an antireflection concave-convex structure for suppressing reflection of light is formed on its surface and an optical system, an optical unit and an optical device including the optical member.

### BACKGROUND ART

In recent years, there have been proposed various kinds of optical elements in which antireflection processing for suppressing reflection of light is performed to a surface. As antireflection processing, for example, processing in which an antireflection film is formed of a film (low refractive index film) having a relatively low refractive index, a multilayer film including a low refractive index film and a film (high refractive index film) having a relatively high refractive index which are alternately stacked, or the like on a surface of an optical element (see, for example, Patent Document 1 and the like).

However, to form a low refractive index film or an antireflection multilayer film, a complicated step such as vapor deposition, sputtering or the like has to be performed. Therefore, there arises a problem in which productivity is low and cost is high. Moreover, there is another problem in which a low refractive index film or an antireflection film formed of a multilayer film has an antireflection property exhibiting large dependency on wavelength and incident angle.

In view of the above-described problems, as antireflection processing having relatively less dependency on incident angle and wavelength, which is antireflection properties, for example, processing in which a fine structure (for example, a fine structure including filiform concaves and filiform convexes regularly arranged, a fine structures including cone concaves and cone convexes regularly arranged, or the like and such a structure in which such fine structure units are arranged will be hereinafter referred to an “antireflection concave-convex structure: SWS (Subwavelength Structured Surface)” occasionally) is formed on an optical element surface so that concaves/convexes are regularly formed with a pitch equal to or smaller than a wavelength of incident light has been proposed (see, for example, Non-Patent Documents 1, and the like). With SWS formed on an optical element surface, abrupt change in refractive index at an interface can be suppressed and a moderate distribution of refractive index can be formed at the interface. Accordingly, reflection at the optical element surface is reduced, so that a high rate of incidence for light coming into the optical element can be realized.

Note that in Non-Patent Document 1, it is described that a cycle of a fine structure is preferably set to be 0.4 or more times and 1 or less times as large as the wavelength of light of which reflection is desired to be suppressed.

### Patent Document 1: Japanese Laid-Open Publication No. 2001-127852

Non-Patent Document 1: Daniel H. Raguin and G. Michael Morris, Analysis of antireflection-structured surfaces with continuous one-dimensional surface profiles Applied Optics, Vol. 32, No. 14, pp. 2582-2598, 1993

### DISCLOSURE OF INVENTION

### Problems that the Invention is to Solve

Normally, when a wavelength of incident light is equal to or larger than a pitch of an antireflection concave-convex structure, reflection of the incident light is suppressed. However, because of various factors such as a pitch of an antireflection concave-convex structure, a refractive index of an optical element and an incident angle of light coming into an optical element and the like, diffraction light (reflected diffraction light) might be generated even when a wavelength of incident light is larger than the pitch of the antireflection concave-convex structure.

When diffraction light is generated, the diffraction light becomes noise light and might cause reduction in optical performance of the optical element, or an optical system or an optical device provided with the optical element. For example, there might be cases where when diffraction light is generated in an optical element constituting a pickup optical system (such as an optical disc optical system), the diffraction light comes into a detector and largely affects a servo signal and a reproduction signal. Therefore, it is preferable that an antireflection concave-convex structure having a small pitch which allows prevention of the generation of diffraction light is formed on an element surface.

In Non-Patent Document 1, to suppress the generation of diffraction light, a cycle of an antireflection concave-convex structure has to be less than ½ of a wavelength of incident light. According to this, for example, when visible light (i.e., light within a wavelength band of 400 nm to 700 nm) comes into an optical element, the cycle of the antireflection concave-convex structure has to be less than 200 nm, which is very small in order to sufficiently suppress the generation of diffraction light (reflected diffraction light). Therefore, it is very difficult to form an antireflection concave-convex structure in which the generation of the reflection light and also the generation of diffraction light can be suppressed. When a wavelength of incident light is relatively small, it is particularly difficult to form such antireflection concave-convex structure and, depending on cases, it might be not possible to form such antireflection concave-convex structure. In other words, it is difficult to form an optical member in which the generation of reflection light and diffraction light is sufficiently suppressed.

In view of the above-described problems, the present invention has been devised and provides an optical member in which the generation of reflection light and diffraction light is sufficiently suppressed and which can be fabricated in a simple manner.

### Solution to the Problems

The present inventors have found that there are cases where even when a pitch of the antireflection concave-convex structure is equal to or larger than ½ of incident light, diffraction light is not generated, depending on an angle of an incident plane with respect to an antireflection concave-convex structure. Then, the present inventors examined specific condition for such cases and reached to the present disclosure.

A first optical member according to the present disclosure is directed to an optical member in which an antireflection concave-convex structure for suppressing reflection of light, formed of a plurality of fine structure units of filiform convex portions or filiform concave portions regularly arranged, is provided on its surface, and is characterized in that the antireflection concave-convex structure is configured so that an angle between a normal vector of an incident plane of the light whose reflection is to be suppressed and a vector connecting respective apexes of adjacent two of the structure units at the incident plane is 60 degrees or less.

A second optical member according to the present disclosure is directed to an optical member in which an antireflection concave-convex structure for suppressing reflection of light, formed of a plurality of fine structure units of filiform convex portions or filiform concave portions regularly arranged, is provided on its surface, and is characterized in that the optical member is arranged for use so that an angle between a normal vector of an incident plane of the light whose reflection is to be suppressed and a vector connecting respective apexes of adjacent two of the structure units at the incident plane is 60 degrees or less.

A third optical member according to the present disclosure is directed to an optical member in which an antireflection concave-convex structure for suppressing reflection of light, formed of a plurality of fine structure units of cone convex portions or cone concave portions regularly arranged, is provided on its surface, and is characterized in that the antireflection concave-convex structure is configured so that a difference between an angle between a normal vector of an incident plane of the light whose reflection is to be suppressed and one of two vectors one of which connects an apex of one of the structure units to an apex of one adjacent structure unit and the other of which connects the apex of the one structure unit to an apex of another adjacent structure unit and an angle between the normal vector and the other one of the two vectors is 30 degrees or less.

A fourth optical member according to the present disclosure is directed to an optical member in which an antireflection concave-convex structure for suppressing reflection of light, formed of a plurality of fine structure units of cone convex portions or cone concave portions regularly arranged, is provided on its surface, and is characterized in that the optical member is arranged for use so that a difference between an angle between a normal vector of an incident plane of the light whose reflection is to be suppressed and one of two vectors one of which connects an apex of one of the structure units to an apex of one adjacent structure unit and the other of which connects the apex of the one structure unit to an apex of another adjacent structure unit and an angle between the normal vector and the other one of the two vectors is 30 degrees or less.

An optical system according to the present disclosure is characterized by including any one of the optical members of the present disclosure.

An optical unit according to the present disclosure is characterized by including the optical system of the present disclosure.

An optical device according to the present disclosure is characterized by including the optical unit of the present disclosure.

### ADVANTAGES OF THE INVENTION

According to the present disclosure, an optical member in which the generation of reflection light and diffraction light is sufficiently suppressed and which can be fabricated in a simple manner is achieved.

### BRIEF DESCRIPTION OF DRAWINGS

FIG. 1 is a diagram illustrating a configuration of major part of an imaging device 10 according to Embodiment 1.

FIG. 2(a) and FIG. 2(b) are perspective views illustrating a lens tube 1.

FIG. 3 is a graph showing the relationship between a maximum pitch of an antireflection concave-convex structure 15 in which diffraction light is not substantially generated and an angle ψᵢ.

FIG. 4 is a schematic diagram of incident light entering the antireflection concave-convex structure 15 with a triangular cross section.

FIG. 5 is a further schematic diagram illustrating a model shown in FIG. 4 when the angle ψᵢ is 90 degrees.

FIG. 6 is a conceptual diagram describing conditions under which diffraction light is generated when the angle ψᵢ is arbitrary.

FIG. 7 is a conceptual diagram of a boundary surface 201 when viewed from a normal vector direction 107.

FIG. 8 is a schematic diagram showing the relationship between the antireflection concave-convex structure 15 and incident light when the angle ψᵢ is 0 degree.

FIG. 9 is a graph showing the correlation between incident angle and reflectivity when the angle ψᵢ is 0 degree.

FIG. 10 is a schematic diagram showing the relationship between the antireflection concave-convex structure 15 and incident light when the angle ψᵢ is 90 degree.

FIG. 11 is a graph showing the correlation between incident angle reflectivity when the angle ψᵢ is 90 degrees.

FIG. 12 is a diagram illustrating a configuration of major part of an optical pickup system 20 according to Embodiment 2.

FIG. 13 is a cross-sectional view of an objective lens 2.

FIG. 14 is a schematic plan view of the objective lens 2 when viewed from a lens surface 2a side.

FIG. 15 is a schematic plan view illustrating enlarged part XV of FIG. 14.

FIG. 16 is a schematic plan view illustrating enlarged part XVI of FIG. 14.

FIG. 17 is a schematic plan view illustrating enlarged part XVII of FIG. 14.

FIG. 18 is a graph showing the correlation of a maximum pitch of a antireflection concave-convex structure 26 in which diffraction light is not substantially generated with an angle ψᵢ(1) and an angle ψᵢ(2) when an angle between a lattice vector (1) and a lattice vector (2) is 90 degrees.

FIG. 19 is a graph showing the correlation of the maximum pitch of the antireflection concave-convex structure 26 in which diffraction light is not substantially generated with an angle ψᵢ(1) and an angle ψᵢ(2) when an angle between a lattice vector 1 and a lattice vector 2 is 120 degrees.

FIG. 20 is a conceptual diagram showing the relationship between an angle between the lattice vector (1) and a normal vector of an incident plane and an angle between the lattice vector (2) and the normal vector.

FIG. 21(a) and FIG. 21(b) are schematic diagrams showing the relationship between the antireflection concave-convex structure 26 and an incident plane when a difference between ψᵢ(1) and ψᵢ(2) is 90 degrees.

FIG. 22 is a graph showing the correlation between incident angle and reflectivity when the difference between ψᵢ(1) and ψᵢ(2) is 90 degrees.

FIG. 23(a) and FIG. 23(b) are schematic diagrams showing the relationship between the antireflection concave-convex structure 26 and an incident plane when a difference between ψᵢ(1) and ψᵢ(2) is 0 degree.

FIG. 24 is a graph showing the correlation between incident angle and reflectivity when the difference between ψᵢ(1) and ψᵢ(2) is 0 degree.

FIG. 25 is a diagram illustrating a configuration of major part of a copying machine 30 according to Embodiment 3.

FIG. 26 is a schematic plan view of a surface 41a of a platen glass 41.

FIG. 27 is a diagram illustrating a configuration of major part of a light scanning unit (LSU) 57.

FIG. 28 is a cross-sectional view of part cut out along a cut out line XXVIII-XXVIII of FIG. 27.

### EXPLANATION OF REFERENCE NUMERALS

1 Lens tube
2 Objective lens
10 Imaging device
11 Lens tube unit
13 Image formation optical system
15, 26, 70, 85 Antireflection concave-convex structure
16, 86 Filiform convex portion
20 Optical pickup system
25 Detector
27, 71 Cone convex portion
30 Copying machine
40 Image reading unit
41 Platen glass
57 Light scanning unit
84 fθ lens

### BEST MODE FOR CARRYING OUT THE INVENTION

Hereinafter, embodiments of the present invention will be described in detail with reference to the accompanying drawings.

### Embodiment 1

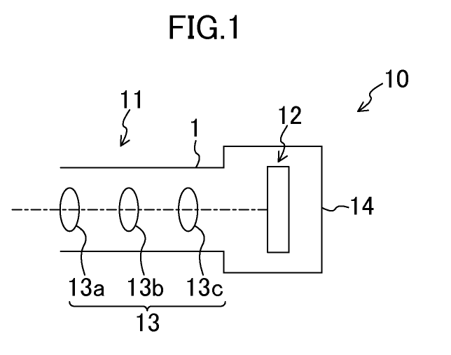

FIG. 1 is a diagram illustrating a configuration of major part of an imaging device 10 according to Embodiment 1 of the present invention.

As shown in FIG. 1, the imaging device 10 of Embodiment 1 includes a device body 14, a lens tube unit 11 and an imaging element 12. The lens tube unit 11 includes a lens tube 1 (specifically, having a cylindrical shape) and an image formation optical system 13 placed in the lens tube 1. The image formation optical system 13 is provided to form an image of incident light coming into the lens tube 1 from an image side (i.e., a left side in FIG. 1). In Embodiment 1, specifically, the image formation optical system 13 is formed of a first lens 13a, a second lens 13b and a third lens 13c. Note that each of the lenses 13a through 13c constituting the image formation optical system 13 may be arranged along an optical axis so as not to be displaceable. Moreover, the lenses 13a through 13c may be formed so that at least one of the lenses is displaceable along the optical axis to perform focusing and reducing/enlarging an image.

The lens tube unit 11 is attached to the device body 14. The lens tube unit 11 may be removable from the device body 14 or may be unremovable from the device body 14.

In the device body 14, an imaging element 12 is provided. The imaging element 12 is arranged at a point of the optical axis of the image formation optical system 13. Specifically, the imaging element 12 has an imaging surface and is arranged so that an optical image is formed on the imaging surface by the image formation optical system 13. The imaging element 12 has a function as an optical detector. Specifically, the imaging element 12 has the function of detecting a formed optical image and outputting an electrical signal corresponding to the optical image. The imaging element 12 can be formed of, for example, a CCD (charge coupled device), a COMS (complementary metal-oxide semiconductor) or the like.

In Embodiment 1, an electrical signal output from the imaging element 12 is input to a recording device (for example, hard disk or the like) which is placed in the device body 14 and is not shown in FIG. 1, and is recorded in the recording device. Note that the imaging device 10 is provided to take in outside light through the lens tube unit 11 and convert an obtained optical image to an electrical signal and thus is used in an environment where a light source (which may be, for example, the sun) is present.

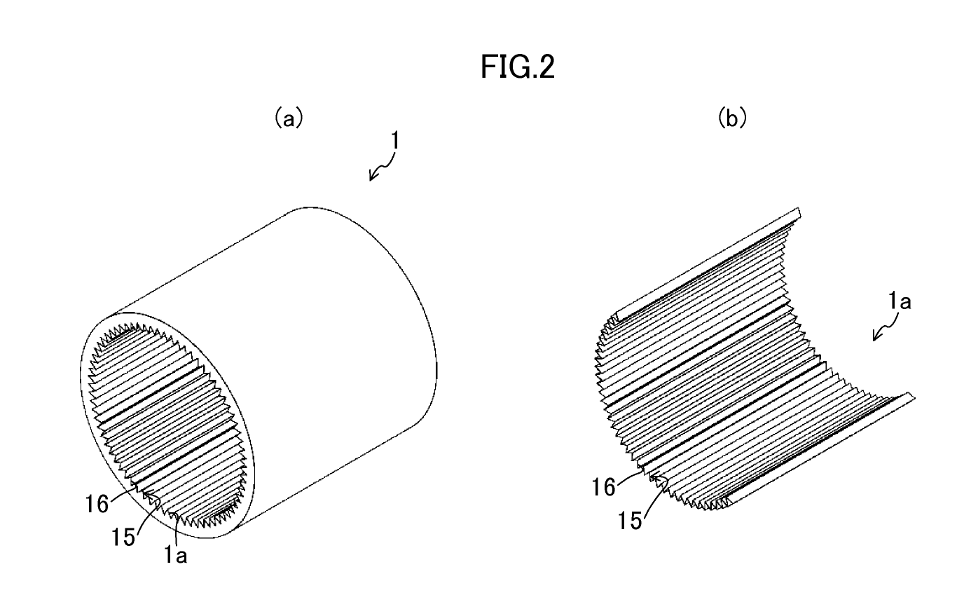

FIG. 2(a) and FIG. 2(b) are perspective views illustrating a lens tube 1. Specifically, FIG. 2(a) is a perspective view of a lens tube 1. FIG. 2(b) is a perspective view of part of an interior surface 1a of the lens tube 1.

In principle, the image formation optical system 13 is designed so that incident light coming into the image formation optical system 13 is formed into an image on the imaging element 12. However, part of incident light coming into the image formation optical system 13, such as light of which an incident angle is equal to or larger than a maximum field angle of the image formation optical system 13 and the like, enters the interior surface 1a of the lens tube 1 without being formed into an image on the imaging element 12. Therefore, when a light reflectivity of the interior surface 1a of the lens tube 1 is high, reflection light (stray light) might be generated in the interior surface 1a and cause a ghost image, flare and the like.

In Embodiment 1, the lens tube 1 is formed so as to have a cylindrical shape and an antireflection concave-convex structure (which is so-called SWS) 15 is formed on the entire interior surface 1a. The antireflection concave-convex structure 15 is formed of a plurality of fine filiform convex portions 16 each of which extends along a direction in which the lens tube 1 extends and which are regularly arranged so as to correspond to the interior surface. Specifically, the plurality of filiform convex portions 16 are arranged with a pitch (which herein means a distance between respective apex portions of every adjacent two of the filiform convex portions 16) equal to or smaller than a wavelength of light coming from the image formation optical system 13. For example, as a specific example, assume that visible light (having a wavelength of 400 nm or more and 700 nm or less) comes into the image formation optical system 13. In the image formation optical system 13, the filiform convex portions 16 are arranged at a pitch equal to or smaller than the smallest wavelength of light (for example, light having a wavelength of 450 nm or more when the imaging element 12 is designed so as not to detect light having a wavelength of 450 nm or less) whose reflection is desired to be suppressed, and the light is included in the incident light coming into the image formation optical system 13. Also, the lens tube 1 is formed so as to absorb light coming from the image formation optical system 13. Specifically, the lens tube 1 includes a light absorbing material (for example, a black dye, a black pigment or the like). Thus, reflection of incident light at the interior surface 1a is sufficiently suppressed and the incident light coming into the lens tube 1 is absorbed by the lens tube 1 at a high absorptance. Accordingly, the generation of stray light due to reflection light at the interior surface 1a and the like can be suppressed. As a result, the generation of a ghost image, flare and the like can be effectively suppressed, so that the imaging device 10 having a high optical performance can be realized.

For example, reflection at the interior surface 1a can be suppressed by forming, on the interior surface 1a, a multilayer film (antireflection multilayer film) of a lamination layer including a low refractive index film and a high refractive index film stacked therein. However, an antireflection multilayer film has wavelength dependency. That is, in some types of antireflection multilayer film, reflection of light having a certain wavelength (designed wavelength) can be preferably suppressed but reflection of light having wave length other than the designed wavelength can not be sufficiently suppressed. In contrast, a SWS has low wavelength dependency, compared to an antireflection multilayer film, and thus has the effect of preferably suppressing reflection of incident light having a wavelength larger than a pitch of the SWS, regardless of a wavelength of incident light. Therefore, with the configuration of Embodiment 1, reflection of lights of various different wavelengths can be effectively suppressed regardless of their wavelength.

Thus, the SWS having relatively small wavelength dependency is effective in use for optical equipment into which light in a certain wavelength band comes, such as, for example, an imaging device which will be described in this embodiment, optical equipment using a plurality of lights having different wavelengths (for example, a so-called multi-compatible optical pickup device or the like) and the like.

An antireflection multilayer film has incident angle dependency. Specifically, with the antireflection multilayer film, reflection of light coming into the film at a relatively small incident angle can be effectively suppressed but reflection of light coming into the film at a relatively large incident angle can not be sufficiently suppressed. Therefore, when an antireflection multilayer film is formed on the interior surface 1a, reflection of light coming into the film at a large incident angle can not be sufficiently suppressed. In contrast, a SWS has low incident angle dependency, compared to an antireflection multilayer film. Thus, a SWS has the function of effectively suppressing not only reflection of light coming into the SWS at a relatively small incident angle but also reflection of light coming into the SWS at a relatively large incident angle. Therefore, with the configuration of Embodiment 1, reflection of light coming into the interior surface 1a at a relatively large angle can be effectively suppressed. In view of effectively suppressing reflection of light coming into the interior surface 1a at a relatively large angle, a surface of the interior surface 1a, serving as a base on which the antireflection concave-convex structure 15 is to be formed, may be formed to be a rough surface.

When a surface of the interior surface 1a, serving as a base on which the antireflection concave-convex structure 15 is to be formed, is formed to be a rough surface, there is an advantage that a specular reflection component with respect to incident light can be effectively suppressed.

Note that as long as the pitch of the antireflection concave-convex structure 15 is equal to or smaller than a wavelength of incident light on the entire interior surface 1a, the pitch of the antireflection concave-convex structure 15 may be approximately constant (i.e., cyclic). Also, the pitch of the antireflection concave-convex structure 15 may vary among different points thereon. That is, the antireflection concave-convex structure 15 may be noncyclic. With an antireflection concave-convex structure 15 formed to be noncyclic, the generation of diffraction light can be effectively suppressed.

As long as each of the filiform convex portions 16 has a cross-section shape which allows a moderate distribution of refractive index at the interior surface 1a, the cross-section shape of each of the filiform convex portions 16 is not particularly limited. For example, the filiform convex portions 16 may be formed so that each of the filiform convex portions 16 has a triangular cross section (of which an apex portion may be chamfered or R-chamfered, or of which at least one side may be replaced with a curved line), a domal cross section, a semicircle cross section, a semielliptical cross section or the like.

A height of the filiform convex portions 16 (i.e., a distance from a surface of the interior surface 1a serving as a base to the apex portion of each of the filiform convex portions 16) is preferably set to be 0.4 times or more as large as the longest wavelength in a wavelength band of incident light. Thus, the generation of reflection light at the interior surface 1a can be more effectively suppressed.

In Embodiment 1, the antireflection concave-convex structure 15 is formed so that an angle between a normal vector of an incident plane of light entering the antireflection concave-convex structure 15 and a vector (which will be hereinafter referred to as a “lattice vector” occasionally) connecting respective apex portions of adjacent two of the filiform convex portions 16 at the incident plane is 60 degrees or less. In other words, the lens tube 1 is arranged so that an angle ψᵢ between a normal vector of an incident plane of light entering the antireflection concave-convex structure 15 and a lattice vector is 60 degrees or less.

A maximum pitch of the antireflection concave-convex structure 15 with which diffraction light is not substantially generated correlates with the angle ψᵢ.

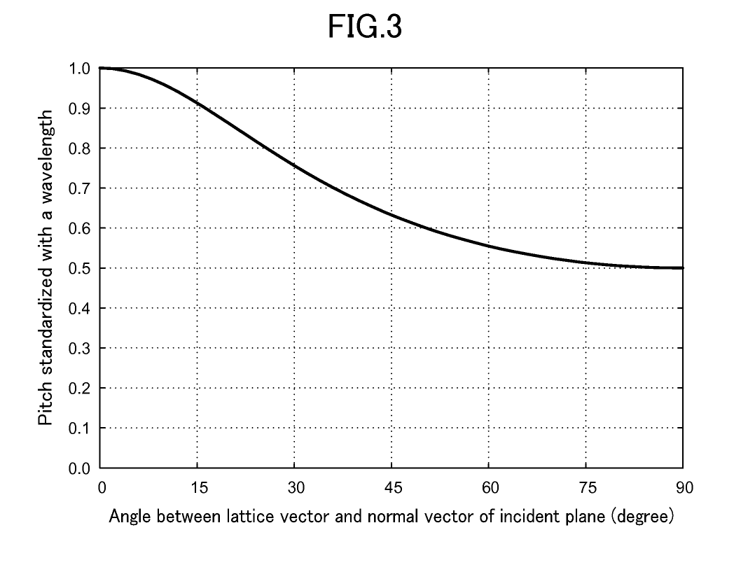

In FIG. 3, the correlation between the maximum pitch of the antireflection concave-convex structure 15 with which diffraction light is not substantially generated and the angle ψᵢ between the lattice vector and the normal vector of the incident plane is shown. A curved line of in FIG. 3 indicates the maximum pitch of the antireflection concave-convex structure 15 with which diffraction light is not substantially generated. That is, when the maximum pitch is in a region below the curved line in FIG. 3, diffraction light is not substantially generated.

As shown in FIG. 3, there can be seen a tendency that the maximum pitch of the antireflection concave-convex structure 15 with which diffraction light is not substantially generated is increased as the angle ψᵢ is reduced. In other words, there is a tendency that as the angle ψᵢ is reduced, diffraction light is not substantially generated even from incident light having a relatively large wavelength.

For example, when the angle ψᵢ is 90 degrees, as conventionally said, the maximum pitch of the antireflection concave-convex structure 15 with which diffraction light is not substantially generated is less than 0.5 (½) times as large as a wavelength of incident light. That is, to prevent the generation of diffraction light, the pitch of the antireflection concave-convex structure 15 has to be less than 0.5 times as large as the wavelength of the incident light. For example, in Embodiment 1 in which visible light comes into the interior surface 1a, the pitch has to be set to be less than about 200 nm. Therefore, it is very difficult to form the antireflection concave-convex structure 15.

With reduction in the angle ψᵢ to a smaller angle than 90 degrees, the maximum pitch of the antireflection concave-convex structure 15 with which diffraction light is not substantially generated is increased. More specifically, when the angle ψᵢ is within a range from 60 degrees to 90 degrees, the maximum pitch of the antireflection concave-convex structure 15 with which diffraction light is not substantially generated is not largely increased with respect to the reduction in the angle ψᵢ. Around a point where the angle ψᵢ becomes 60 degrees or less, an increase rate of the maximum pitch of the antireflection concave-convex structure 15 with which diffraction light is not substantially generated with respect to the reduction in the angle ψᵢ is abruptly increased. Particularly, when the angle ψᵢ is within a range of 15 degrees or more and 60 degrees or less, an increase amount of the maximum pitch of the antireflection concave-convex structure 15 with which diffraction light is not substantially generated with respect to the reduction in the angle ψᵢ is large.

Specifically, when the angle ψᵢ is 75 degrees, the maximum pitch of the antireflection concave-convex structure 15 with which diffraction light is not substantially generated is slightly larger than the maximum pitch when the angle ψᵢ is 90 degrees, but the maximum pitch is not largely changed. When the angle ψᵢ is further reduced from 75 degrees, the increase amount of the maximum pitch of the antireflection concave-convex structure 15 with which diffraction light is not substantially generated is gradually increased with respect to the reduction in the angle ψᵢ. Then, when the angle ψᵢ is 60 degrees, the maximum pitch of the antireflection concave-convex structure 15 with which diffraction light is not substantially generated is about 0.5547 times as large as a wavelength of incident light. That is, the generation of diffraction light can be suppressed when the pitch of the antireflection concave-convex structure 15 is set to be less than about 0.5547 times as large as a wavelength of incident light. This means that by setting the angle ψᵢ to be 60 degrees, the pitch of the antireflection concave-convex structure 15 can be increased by about 10%, compared to that of the case where the angle ψᵢ is 90 degrees (or the pitch can be increased to be about 1.1 times as large as the pitch when the angle ψᵢ is 90 degrees). Specifically, assuming that incident light is visible light, if the angle ψᵢ is 90 degrees, the pitch of the antireflection concave-convex structure 15 has to be less than 200 nm, which is very small. However, in contrast, if the angle ψᵢ is 60 degrees, the pitch of the antireflection concave-convex structure 15 can be set to be less than 222 nm, which is relatively large. Thus, the antireflection concave-convex structure 15 can be formed in a simple manner.

Around a point where the angle ψᵢ becomes less than 60 degrees, the increase rate of the maximum pitch of the antireflection concave-convex structure 15 with which diffraction light is not substantially generated is abruptly increased and, when the angle ψᵢ is 45 degrees, the maximum pitch of the antireflection concave-convex structure 15 with which diffraction light is not substantially generated is about 0.6325 times as large as a wavelength of incident light. That is, the generation of diffraction light can be suppressed when the pitch of the antireflection concave-convex structure 15 is set to be less than about 0.6325 times as large as a wavelength of incident light. This means that by setting the angle ψᵢ to be 45 degrees, the pitch of the antireflection concave-convex structure 15 can be increased by about 20%, compared to that of the case where the angle ψᵢ is 90 degrees (or the pitch can be increased to be about 1.2 times as large as the pitch when the angle ψᵢ is 90 degrees). Specifically, when incident light is visible light, the pitch of the antireflection concave-convex structure 15 can be set to be less than 253 nm, which is even larger. Thus, the antireflection concave-convex structure 15 can be formed in a simple manner.

The maximum pitch of the antireflection concave-convex structure 15 with which diffraction light is not substantially generated can be further increased by further reducing the angle ψᵢ from 45 degrees. When the angle ψᵢ is 15 degrees, the maximum pitch of the antireflection concave-convex structure 15 with which diffraction light is not substantially generated is about 0.9125 times as large as a wavelength of incident light. That is, the generation of diffraction light can be suppressed when the pitch of the antireflection concave-convex structure 15 is set to be less than about 0.9125 times as large as a wavelength of incident light. This means that by setting the angle ψᵢ to be 15 degrees, the pitch of the antireflection concave-convex structure 15 can be increased by about 80%, compared to that of the case where the angle ψᵢ is 90 degrees (or the pitch can be increased to be about 1.8 times as large as the pitch when the angle ψᵢ is 90 degrees). Specifically, when incident light is visible light, the pitch of the antireflection concave-convex structure 15 can be set to be less than 365 nm, which is relatively large. Thus, the antireflection concave-convex structure 15 can be formed in a simple manner.

When the angle ψᵢ is further reduced to a smaller angle than 15 degrees, as in the same manner as described above, the maximum pitch of the antireflection concave-convex structure 15 with which diffraction light is not substantially generated is increased as the angle ψᵢ is reduced. However, the increase rate is smaller than that of the case where the angle ψᵢ is an angle of more than 15 degrees and 60 degrees or less. As a result, even when the angle ψᵢ is reduced to 0 degree, the pitch of the antireflection concave-convex structure 15 can be increased only to about 1.1 times as large as a wavelength of incident light. That is, when the angle ψᵢ is set to be less than 15 degrees, the pitch of the antireflection concave-convex structure 15 can be made to be sufficiently large.

As has been described, as in Embodiment 1, the lens tube 1 in which diffraction light is not generated and which can be formed in a simple manner can be realized by setting the angle ψᵢ to be 60 degrees or less. The range of the angle ψᵢ is more preferably 45 degrees or less. Furthermore, the range of the angle ψᵢ is even more preferably 15 degrees or less. Particularly, it is preferable that the angle ψᵢ is substantially 0.

The above-described advantages can be also explained in the following way. When a limit pitch which can be made currently is 200 nm, reflection of light having a wavelength smaller than 400 nm can not be effectively suppressed in a known technique. However, by maintaining a proper angle between a normal vector of an incident plane of light entering the antireflection concave-convex structure 15 and a lattice vector in the manner described in this embodiment, reflection of light having a smaller wavelength, i.e., a wavelength smaller than 400 nm can be suppressed. When the formation limit pitch is assumed to be 200 nm, reflection of light having a wavelength of about 360 nm or more can be suppressed by setting the angle ψᵢ to be 60 degrees. Reflection of light having a wavelength of about 316 nm or more can be suppressed by setting the angle ψᵢ to be 45 degrees. Reflection of light having a wavelength of about 219 nm or more can be suppressed by setting the angle ψᵢ to be 15 degrees. Furthermore, reflection of light having a wavelength of about 200 nm or more can be suppressed by setting the angle ψᵢ to be 0 degree.

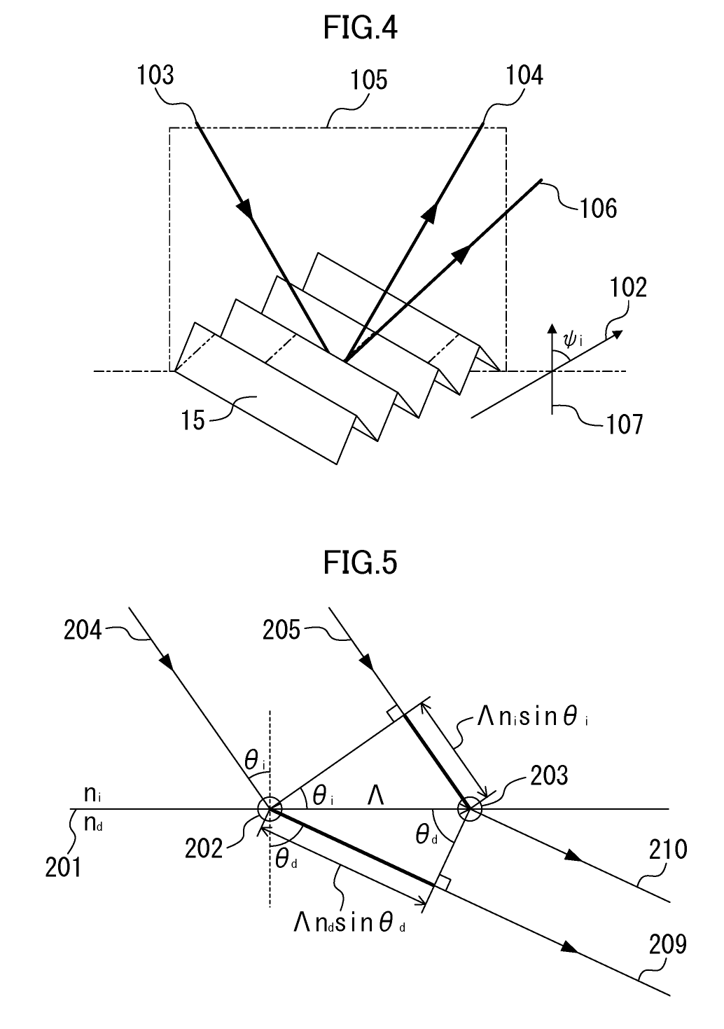

Next, derivation of data of FIG. 3 will be described in detail with reference to FIGS. 4 through 7.

FIG. 4 is a schematic diagram of incident light entering the antireflection concave-convex structure 15 with a triangular cross section.

In FIG. 4, an incident plane 105 is defined by incident light 103 and reflection light 104 thereof. Using a model shown in FIG. 4, the relationship between an incident angle of the incident light 103 and a diffract angle of diffraction light 106 when an angle ψᵢ between a normal vector 107 and a lattice vector 102 is 90 degrees will be described.

FIG. 5 is a further schematic diagram illustrating a model shown in FIG. 4 when the angle ψᵢ is 90 degrees.

In FIG. 5, adjacent two of filiform convex portions 16 constituting an antireflection concave-convex structure 15 are indicated by lattice points 203 and 202 which are arranged with a cycle Λ. Also, an interior surface 1a on which the antireflection concave-convex structure 15 is formed is schematically shown by a boundary surface 201. A refractive index of a light incident portion of the boundary surface 201 is nᵢ and a refractive index of a light diffraction portion of the boundary surface 201 is n_{d}. Collimated light beams 204 and 205 enter the antireflection concave-convex structure 15 toward the lattice points 202 and 203, respectively, at an incident angle θᵢ.

As shown in FIG. 5, an optical path difference for the incident light 204 is Λn_{d} sin θ_{d}. An optical path difference for the incident light 205 is Λnᵢ sin θᵢ. When each of the optical path difference Λn_{d} sin θ_{d} for the incident light 204 and the optical path difference Λnᵢ sin θ, for the incident light 205 is an integral multiple of a wavelength of the incident lights of 204 and 205, diffraction light beams 209 and 210 are generated. That is, when Formula (1) below is satisfied, diffraction light is generated.

[Formula 1]

Λ(n_{d} sin θ_{d}−nᵢ sin θᵢ)=mλ (1)

Note that m is a diffraction order (an integer number).

In this case, the condition for diffraction light not to be generated at a maximum incident angle θₘₐₓ is that whatever value the angle θ_{d} takes, an absolute value in the left side of Formula (1) is smaller than the wavelength. That is, the condition is that Formula (2) below is satisfied.

$$\begin{matrix}[ Formula 2 ] & \\ \frac{Λ}{λ} < \frac{1}{{n}_{d} + {n}_{i} sin {θ}_{max}} & ( 2 )\end{matrix}$$

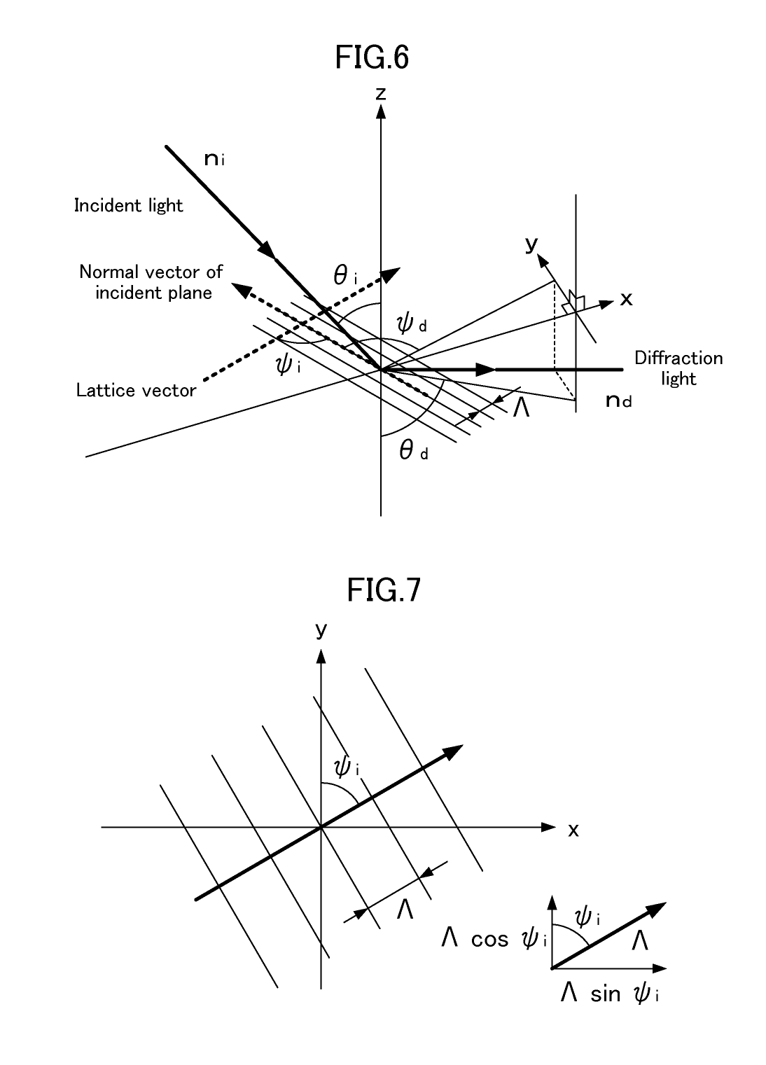

Next, with reference to FIG. 6, the case where the angle ψᵢ is arbitrary will be described.

FIG. 6 is a conceptual diagram describing conditions under which diffraction light is generated when the angle ψᵢ is arbitrary. In FIG. 6,

Y-axis is the normal vector 107 of the incident plane 105, and
φ_{d} is an angle between the diffraction light 209 and 210 and the normal vector 107.

FIG. 7 is a conceptual diagram of a boundary surface 201 when viewed from a normal vector direction 107.

In this case, the cycle Λ can be resolved into an X direction component including the incident plane 105 and a Y direction component vertical to the incident plane 105. The X direction component and the Y direction component of the cycle Λ are expressed by Formula (3) below.

$$\begin{matrix}[ Formula 3 ] & \\ \{ \begin{matrix}X component \text{:} {Λsinϕ}_{i} \\ Y component \text{:} {Λcosϕ}_{i}\end{matrix} & ( 3 )\end{matrix}$$

Incident light is present in an XZ plane. Therefore, for incident light, only an optical path difference at the XZ plane has to be considered (that is, for incident light, an optical path difference for incident light at a YZ plane is 0). The optical path difference for incident light at the XZ plane is expressed by Formula (4) below.

[Formula 4]

Λnᵢ sin φᵢ sin θᵢ (4)

In contrast, diffraction light is not necessarily present in the XZ plane. Therefore, an optical path difference for diffraction light has to be resolved into a component in the XZ plane and a component in the YZ component and the components has to be taken into consideration. An optical path difference for diffraction light at the XZ plane is given by Formula (5) below.

[Formula 5]

Λn_{d} sin φᵢ sin θ_{d} (5)

Accordingly, a difference between respective optical path differences for incident light and diffraction light at the XZ plane are expressed by Formula (6) below.

[Formula 6]

Λn_{d} sin φᵢ sin θ_{d}−Λnᵢ sin φᵢ sin θᵢ (6)

Since the optical path difference for incident light at the YZ plane is 0, a difference between respective optical path differences for incident light and diffraction light at the YZ plane is given by Formula (7) below.

[Formula 7]

Λn_{d} cos φᵢ sin φ_{d} (7)

The condition for diffraction light to be generated is that a square root of a square sum of respective optical path differences of Formula (6) and Formula (7) is an integral multiple of a wavelength. That is, the condition for diffraction light to be generated is expressed by Formula (8) below.

$$\begin{matrix}[ Formula 8 ] & \\ Λ ( \sqrt{{( {n}_{d} sin {ϕ}_{i} sin {θ}_{d} - {n}_{i} sin {ϕ}_{i} sin {θ}_{i} )}^{2} + {( {n}_{d} cos {ϕ}_{i} sin {ϕ}_{d} )}^{2}} ) = \vert m λ \vert & ( 8 )\end{matrix}$$

The condition for diffraction light not to be generated at the maximum incident angle θₘₐₓ is that whatever values θ_{d} and φ_{d} take, an absolute value in the left side of Formula (6) is smaller than the wavelength. That is, the condition for diffraction light not to be generated at the maximum incident angle θₘₐₓ is expressed by Formula (9).

$$\begin{matrix}[ Formula 9 ] & \\ \frac{Λ}{λ} < \frac{1}{\sqrt{{[ sin {ϕ}_{i} ( {n}_{d} + {n}_{i} sin {θ}_{max} ) ]}^{2} + {( {n}_{d} cos {ϕ}_{i} )}^{2}}} & ( 9 )\end{matrix}$$

When light comes from air at an arbitrary incident angle (of 0 to 90 degrees), n_{d}=nᵢ=1 and θₘₐₓ=90° hold. Therefore, Formula (9) can be resolved into Formula (10) below.

$$\begin{matrix}[ Formula 10 ] & \\ \frac{Λ}{λ} < \frac{1}{1 + 3 {sin}^{2} {ϕ}_{i}} & ( 10 )\end{matrix}$$

A curved line of FIG. 3 is a graph of Formula (10) obtained in the above-described manner.

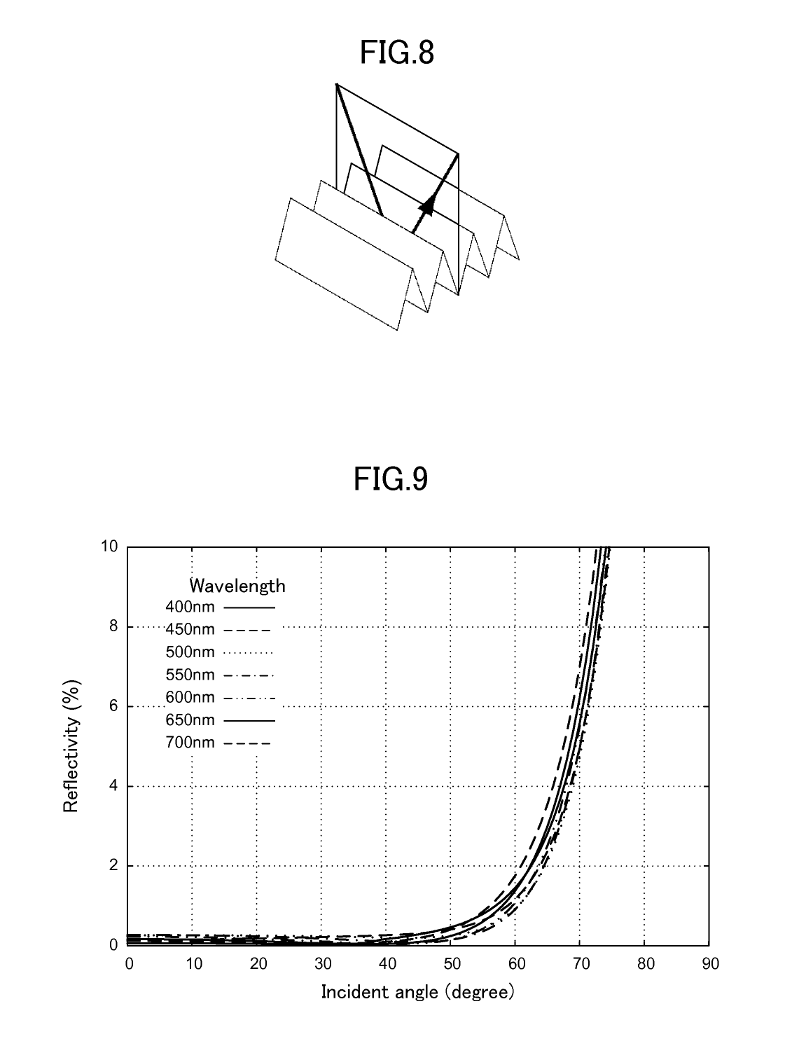

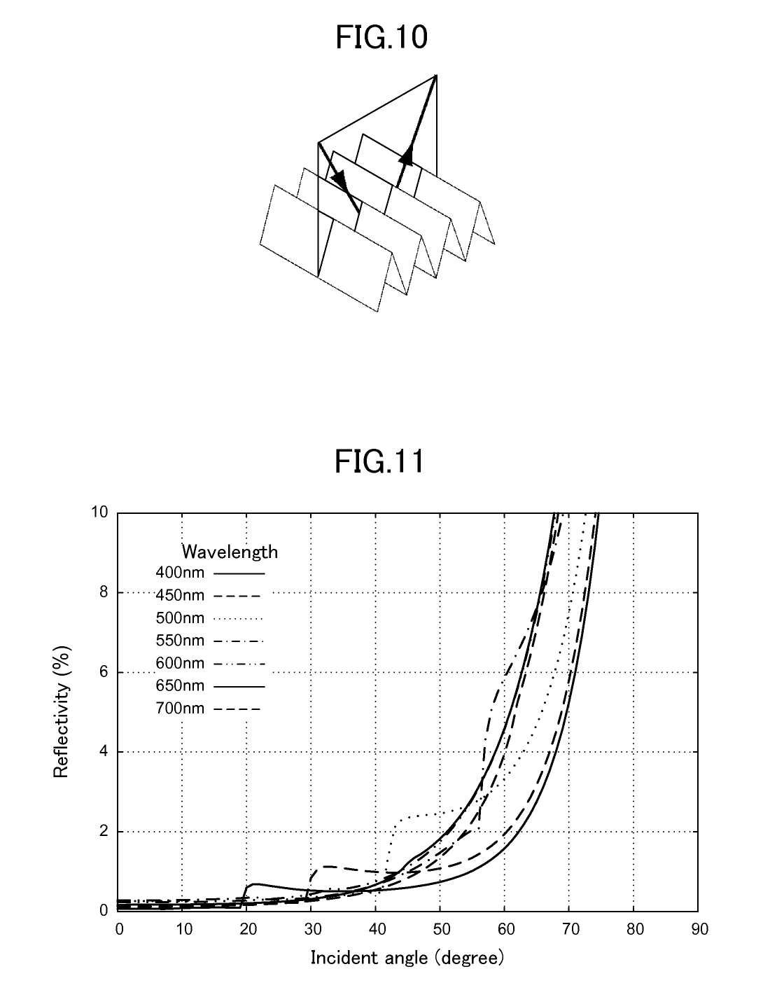

Note that FIG. 8 is a schematic diagram showing the relationship between the antireflection concave-convex structure 15 and incident light when the angle ψᵢ is 0 degree. FIG. 9 is a graph (for simulation results) showing the correlation between incident angle and reflectivity when the angle ψᵢ is 0 degree. FIG. 10 is a schematic diagram showing the relationship between the antireflection concave-convex structure 15 and incident light when the angle ψᵢ is 90 degrees. FIG. 11 is a graph (for simulation results) showing the correlation between incident angle and reflectivity when the angle ψᵢ is 90 degrees. Note that results indicated in FIG. 9 and FIG. 11 were calculated assuming that the antireflection concave-convex structure 15 was formed so that a plurality of fine filiform convex portions 16 each of which had a height of 300 nm and had a triangular cross section were cyclically arranged with a cycle of 300 nm. In the simulation, it was also assumed that light entered the antireflection concave-convex structure 15 having a refractive index of 1.46 from a solvent having a refractive index of 1. For wavelength, a wavelength was plotted every 50 nm in a range from 400 nm to 700 nm. Light was non-polarized light.

When the angle ψᵢ is 90 degrees, diffraction light is generated at a specific incident angle and, as shown in FIG. 11, at the specific incident angle, reflectivity is abruptly increased. For example, for incident light having a wavelength of 400 nm, reflected diffraction light is generated at an incident angle of 20 degrees and reflectivity is 5 times or more as large as reflectivity of the case where reflected diffraction light is not generated. On the other hand, when ψᵢ=0° holds, as shown in FIG. 9, diffraction light is not generated at an incident angle of 0 to 90 degrees. Therefore, reflectivity is not increased abruptly at a specific incident angle.

In Embodiment 1, the example where the antireflection concave-convex structure 15 is formed of a plurality of fine filiform convex portions 16 arranged therein has been described. However, for example, the antireflection concave-convex structure 15 may be formed of a plurality of fine filiform concave portions (for example, each of which has a triangular cross section (of which an apex portion may be chamfered or R-chamfered, or of which at least one side may be replaced with a curved line) or a domal cross section, a semicircle cross section, a semielliptical cross section or the like) regularly arranged. That is, as long as the antireflection concave-convex structure 15 is formed so that reflectivity gradually changes at its surface, the antireflection concave-convex structure 15 is not particularly limited to a certain structure. Note that in this specification, an apex portion of a filiform concave portion means a lowest point of the filiform concave portion.

Also, in Embodiment 1, the example where SWS is formed on the entire interior surface 1a has been described. However, for example, when in the interior surface 1a, there is a region into which light does not come or when in the interior surface 1a, there is a region in which the generation of reflection of light is acceptable in view of optical designing, SWS does not necessarily have to be formed on the entire interior surface 1a.

### Embodiment 2

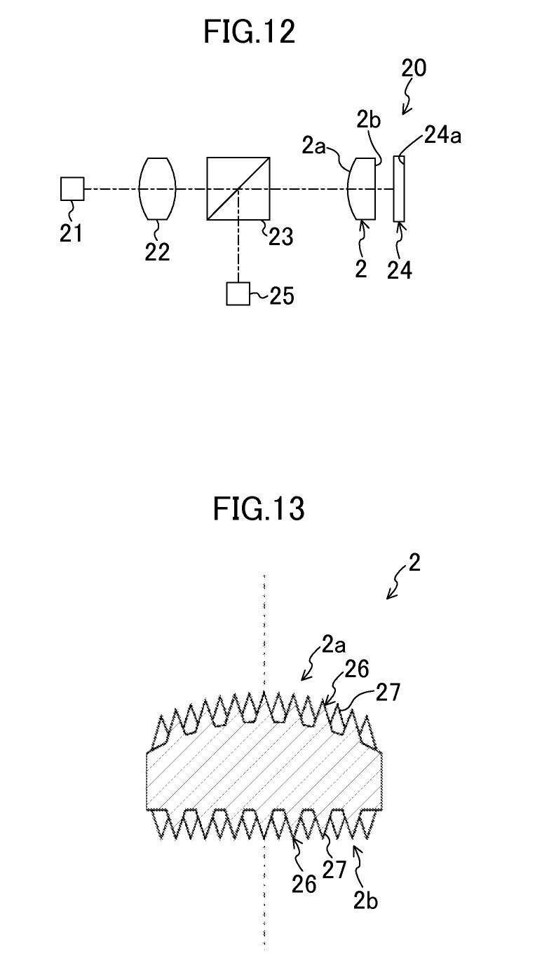

FIG. 12 is a diagram illustrating a configuration of major part of an optical pickup system 20 according to Embodiment 2 of the present invention. Specifically, FIG. 12 is a diagram illustrating only a pickup unit of the optical pickup system 20.

The optical pickup system 20 of Embodiment 2 is configured so that laser light is focused on an information recording surface 24a of an information recording medium (for example, an optical disc or the like) 24 and reflection light at the information recording surface 24a is detected and thereby perform reading of information recorded on the information recording surface 24a.

The optical pickup system 20 includes a laser light source 21, a collimator 22, a beam splitter 23, an objective lens 2 constituting an objective optical system and a detector 25. The collimator 22 has a function of converting a laser beam emitted from the laser light source 21 into collimated light. Collimated laser light converted by the collimator 22 is transmitted through the beam splitter 23 and comes into the objective lens 2. The objective lens 2 is provided to focus laser light on the information recording surface 24a of the information recording medium 24 set therein. Focused laser light by the objective lens 2 is reflected by the information recording surface 24a. The reflection light is transmitted through the objective lens 2 and comes into the beam splitter 23. The reflection light is reflected by a reflection surface provided in the beam splitter 23 and is guided to the detector 25. In the detector 25, reflection light is detected and, based on the detected reflection light, data is read out.

Note that in Embodiment 2, an example of the present invention is described, using as an example, the optical pickup system 20 of a type in which focusing of laser light on a single type of the information recording medium 24. However, for example, the disclosure of the present invention can be applied to a so-called multi-compatible type in which laser light can be focused on each of a plurality types of the information recording medium 24.

FIG. 13 is a cross-sectional view of the objective lens 2.

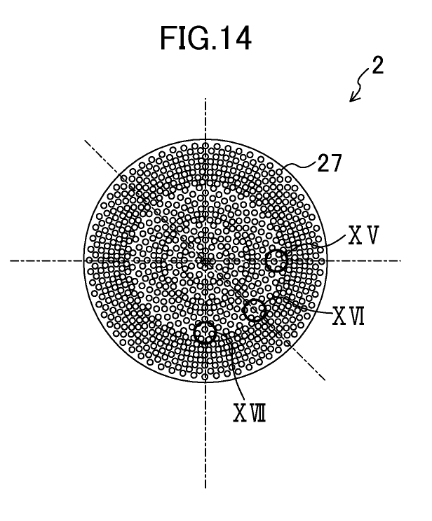

FIG. 14 is a schematic plan view of the objective lens 2 when viewed from a lens surface 2a side.

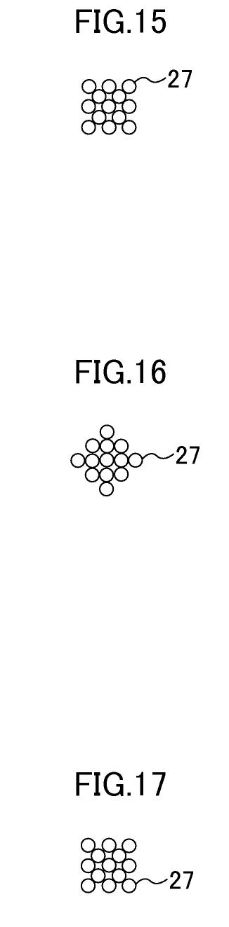

FIG. 15 is a schematic plan view illustrating enlarged part XV of FIG. 14.

FIG. 16 is a schematic plan view illustrating enlarged part XVI of FIG. 14.

FIG. 17 is a schematic plan view illustrating enlarged part XVII of FIG. 14.

As has been described, laser light coming into the objective lens 2 is transmitted through the objective lens 2. However, if a lens surface 2a or a lens surface 2b of the objective lens 2 is not antireflection-processed, part of laser light is reflected at the lens surface 2a or the lens surface 2b. When part of laser light is reflected at the lens surface 2a or the lens surface 2b, a light intensity of laser light detected in the detector 25 is reduced, thus resulting in reduction in detection accuracy. As a result, noise and the like might occur.

In Embodiment 2, an antireflection concave-convex structure 26 formed of a plurality of fine cone convex portions 27 regularly arranged therein is provided at least in an optical effective diameter of the lens surface 2a at the laser light source 21 side. Specifically, the plurality of the cone convex portions 27 are arranged (in a square array or a triangular lattice) with a pitch (i.e., a distance between respective apexes of adjacent two of the cone convex portions 27) smaller than a wavelength of laser light emitted from the laser light source 21.

Also, an antireflection concave-convex structure 26 formed of a plurality of fine cone convex portions 27 regularly arranged therein is provided at least in an optical effective diameter of the lens surface 2b. Specifically, a plurality of the cone convex portions 27 are arranged (in a square array or a triangular lattice) with a pitch (i.e., a distance between respective apexes of adjacent two of the cone convex portions 27) smaller than a wavelength of laser light emitted from the laser light source 21.

Thus, reflection of light at the lens surfaces 2a and 2b of the objective lens 2 can be suppressed. As a result, a light intensity of laser light detected in the detector 25 can be made relatively large and the generation of noise can be effectively suppressed. Therefore, an optical pickup device 20 having a high optical performance can be achieved.

Note that like antireflection concave-convex structure 15 of Embodiment 1, the antireflection concave-convex structure 26 of Embodiment 2 has small dependency on wavelength and incident angle, and thus can realize a higher antireflection effect, compared to the case where an antireflection multilayer film or the like is provided on the lens surfaces 2a and 2b.

In Embodiment 2, as in Embodiment 1, a pitch of the antireflection concave-convex structure 26 may be approximately constant (i.e., cyclic) entirely in the optical effective diameter on each of the lens surfaces 2a and 2b as long as the pitch of the antireflection concave-convex structure 26 is equal to or smaller than a wavelength of laser light. Also, the pitch of the antireflection concave-convex structure 26 may be different between different parts in the optical effective diameter on each of lens surfaces 2a and 2b. That is, the antireflection concave-convex structure 26 may be non-cyclic. With the antireflection concave-convex structure 26 formed to be non-cyclic, the generation of diffraction light at the lens surfaces 2a and 2b can be effectively suppressed.

Note that as long as the cone convex portions 27 has a shape which allows a moderate distribution of refractive index at the lens surfaces 2a and 2b, the shape of each of the cone convex portions 27 is not particularly limited. For example, each of the cone convex portions 27 may be a circular conical shape, a pyramidal shape, a circular conical shape with its apex chamfered or R-chamfered, a pyramidal shape with its apex chamfered or R-chamfered, an oblique conical shape (i.e., oblique circular conical shape and oblique pyramidal shape), an oblique conical shape with its apex chamfered or R-chamfered and the like. The antireflection concave-convex structure 26 may be formed of conical concave portions so that a moderate distribution of refractive index is formed at the lens surfaces 2a and 2b. Note that in this specification, “an apex of a conical concave portion” means a lowest point of the conical concave portion.

A height of the cone convex portions 27 (i.e., a distance from a surface of each of the lens surfaces 2a and 2b serving as a base to an apex of each of the cone convex portion 27) is preferably set to be 0.4 or more times as large as a wavelength of laser light emitted from the laser light source 21. Thus, the generation of reflection light at the lens surfaces 2a and 2b can be effectively suppressed.

In Embodiment 2, the antireflection concave-convex structure 26 is formed so that a difference between an angle ψᵢ(1) between a lattice vector 1 and a normal vector of an incident plane of laser light and an angle ψᵢ(2) between a lattice vector 2 and the normal vector is 30 degrees or less. In other words, the objective lens 2 is arranged so that a difference between an angle ψᵢ(1) between a lattice vector 1 and a normal vector of an incident plane of laser light and an angle ψᵢ(2) between a lattice vector 2 and the normal vector is 30 degrees or less.

Note that the “lattice vector 1” means one of two vectors one of which connects an apex of one of the cone convex portions 27 to an apex of one adjacent cone convex portion 27 and the other of which connects the apex of the one of the cone convex portions 27 to an apex of another adjacent cone convex portion 27, and the “lattice vector 2” means the other one of the two vectors one of which connects an apex of one of the cone convex portions 27 to an apex of one adjacent cone convex portion 27 and the other of which connects the apex of the one of the cone convex portions 27 to an apex of another adjacent cone convex portion 27.

In this case, a maximum pitch of the antireflection concave-convex structure 26 along the lattice vector 1, with which diffraction light is not substantially generated, correlates with the angle ψᵢ(1). A maximum pitch of the antireflection concave-convex structure 26 along the lattice vector 2, with which diffraction light is not substantially generated, correlates with the angle ψᵢ(2).

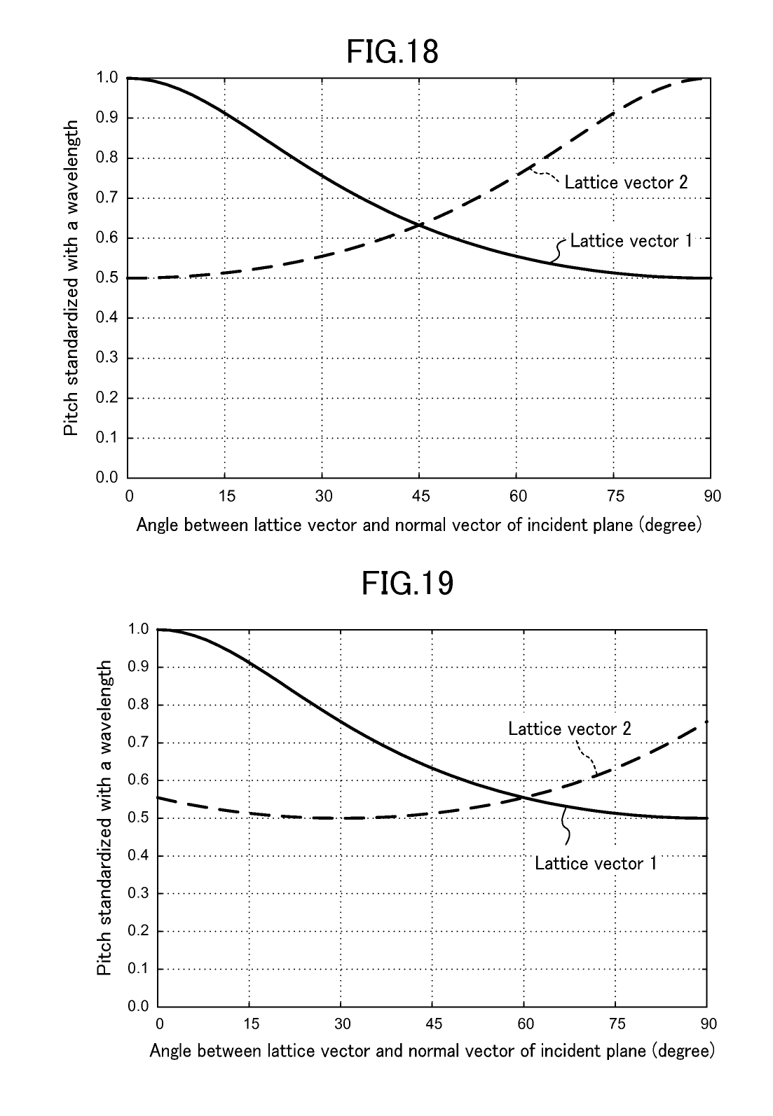

In FIG. 18, the correlation of the maximum pitch of the antireflection concave-convex structure 26 in which diffraction light is not substantially generated with the angle ψᵢ(1) and the angle ψᵢ(2). Data shown in FIG. 18 is data for the case where the angle between the lattice vector 1 and the lattice vector 2 are 90 degrees. That is, the data in FIG. 18 is data for the case where the cone convex portions 27 are arranged in a square array. A solid curved line shown in FIG. 18 indicates the maximum pitch of the antireflection concave-convex structure 26 along the lattice vector 1, with which diffraction light is substantially generated. A dashed curved line in FIG. 18 indicates the maximum pitch of the antireflection concave-convex structure 26 along the lattice vector 2, with which diffraction light is substantially generated. That is, in FIG. 18, diffraction light is not generated in a region on and below the solid curved line and the dashed curved line.

As shown in FIG. 18, there is a tendency that the smaller the angle ψᵢ(1) is, the larger the maximum pitch of the antireflection concave-convex structure 26 along the lattice vector 1, with which diffraction light is not substantially generated, becomes. This shows that a tendency that the pitch of the antireflection concave-convex structure 26 along the lattice vector 1, with which diffraction light is not substantially generated, can be increased as the ψᵢ(1) is reduced. Specifically, the maximum pitch exhibits substantially the same behavior as that of the curved line of FIG. 3, which has been described in Embodiment 1.

There is a tendency, on the other hand, that as the angle ψᵢ(2) is reduced, the maximum pitch of the antireflection concave-convex structure 26 along the lattice vector 2, with which diffraction light is not substantially generated, is reduced. Accordingly, the pitch of the antireflection concave-convex structure 26 along the lattice vector 2 can be increased as the angle ψᵢ(2) is increased. Specifically, the maximum pitch exhibits substantially the opposite behavior as that of the curved line of FIG. 3, which has been described in Embodiment 1.

As a result, assume that the angle ψᵢ(1) is larger than 75 degrees and/or when the angle ψᵢ(2) is less than 15 degrees. Unless smaller one of the maximum pitches of the antireflection concave-convex structure 26 along the lattice vectors 1 and 2, with which diffraction light is not substantially generated, is reduced to about half of a wavelength of laser light, the generation of diffraction light can not be sufficiently suppressed. Because of this, it is difficult to form the antireflection concave-convex structure 26. With the angle ψᵢ(1) set to be 75 degrees or less and the angle ψᵢ(2) set to be 15 degrees or more, the respective maximum pitches of the antireflection concave-convex structure 26 along the lattice vectors 1 and 2, with which diffraction light is not substantially generated, can be made relatively large. Thus, it becomes possible to form the antireflection concave-convex structure 26 in a relatively simple manner. That is, with the cone convex portions 27 arranged in a square array, when a difference between the angle ψᵢ(1) and the angle ψᵢ(2) is set to be 60 degrees or less, the antireflection concave-convex structure 26 which can be formed in a relatively simple manner and in which the generation of diffraction light is substantially prevented can be achieved. More preferable conditions are as follows. The angle ψᵢ(1) is 60 degrees or less and the angle ψᵢ(2) is 30 degrees or more, i.e., the difference between the angle ψᵢ(1) and the angle ψᵢ(2) is 30 degrees or less. Furthermore, it is even more preferable that the angle ψᵢ(1) is 55 degrees or less and the angle ψᵢ(2) is 35 degrees or more, i.e., the difference between the angle ψᵢ(1) and the angle ψᵢ(2) is 20 degrees or less, and that the angle ψᵢ(1) is 50 degrees or less and the angle ψᵢ(2) is 40 degrees or more, i.e., the difference between the angle ψᵢ(1) and the angle ψᵢ(2) is 10 degrees or less. Particularly, it is the most preferable that each of the angle ψᵢ(1) and the angle ψᵢ(2) is substantially 45 degrees. In this case, even if each of the respective pitches of the antireflection concave-convex structure 26 along the lattice vector 1 and the lattice vector 2 is increased to about 0.6325 times as large as a wavelength of laser light, diffraction light is not substantially generated.

FIG. 19 shows the correlation of the maximum pitch of the antireflection concave-convex structure 26, with which diffraction light is not substantially generated, with the angle ψᵢ(1) and the angle ψᵢ(2) when the angle between the lattice vector 1 and the lattice vector 2 is 120 degrees (i.e., when the cone convex portions 27 are arranged (or obliquely arranged) in a triangular lattice). A solid curved line in FIG. 19 indicates the maximum pitch of the antireflection concave-convex structure 26 along the lattice vector 1, with which diffraction light is not substantially generated. A dashed curved line in FIG. 19 indicates the maximum pitch of the antireflection concave-convex structure 26 along the lattice vector 2, with which diffraction light is not substantially generated. That is, in FIG. 19, diffraction light is not generated in a region on and below the solid curved line and the dashed curved line.

In the case shown in FIG. 19, as in the case shown in FIG. 18, there can be seen the following tendency. The smaller the angle ψᵢ(1) is, the larger the maximum pitch of the antireflection concave-convex structure 26 along the lattice vector 1, with which diffraction light is not substantially generated, becomes. On the other hand, the smaller the angle ψᵢ(2) is, the smaller the maximum pitch of the antireflection concave-convex structure 26 along the lattice vector 2, with which diffraction light is not substantially generated, becomes.

With the cone convex portions 27 obliquely arranged, as can be seen from FIG. 19, when the difference between the angle ψᵢ(1) and the angle ψᵢ(2) is set to be 30 degrees or less, the antireflection concave-convex structure 26 which can be formed in a relatively simple manner and in which the generation of diffraction light is substantially prevented can be achieved. The difference between the angle ψᵢ(1) and the angle ψᵢ(2) is more preferably 20 degrees or less, and is even more preferably 10 degrees or less. In this case, each of the angle ψᵢ(1) and the angle ψᵢ(2) is most preferably set to be approximately 60 degrees, and thus smaller one of the respective pitches of the antireflection concave-convex structure 26 along the lattice vector 1 and the lattice vector 2, with which diffraction light is not substantially generated, can be made to be its maximum. In this case, even when each of the respective pitches of the antireflection concave-convex structure 26 along the lattice vector 1 and the lattice vector 2 is set to be about 0.5547 times as large as a wavelength of laser light, diffraction light is not substantially generated.

As has been described, in view of achieving the antireflection concave-convex structure 26 which can be formed in a relatively simple manner and in which the generation of diffraction light is substantially prevented, the difference between the angle ψᵢ(1) and the angle ψᵢ(2) is preferably set to be 30 degrees or less. The difference is more preferably set to be 20 degrees or less, and is even more preferably set to be 10 degrees or less. Furthermore, it is the most preferable to set the angle ψᵢ(1) and the angle ψᵢ(2) so that the maximum pitch of the antireflection concave-convex structure 26 along the lattice vector 1, with which diffraction light is not substantially generated, and the maximum pitch of the antireflection concave-convex structure 26 along the lattice vector 2, with which diffraction light is not substantially generated, are approximately the same and the angle ψᵢ(1) and the angle ψᵢ(2) are approximately the same.

Note that as long as the above-described range in which diffraction light is not substantially generated is satisfied, the pitch of the antireflection concave-convex structure 26 along the lattice vector 1 and the pitch of the antireflection concave-convex structure 26 along the lattice vector 2 can be approximately the same or may be different.

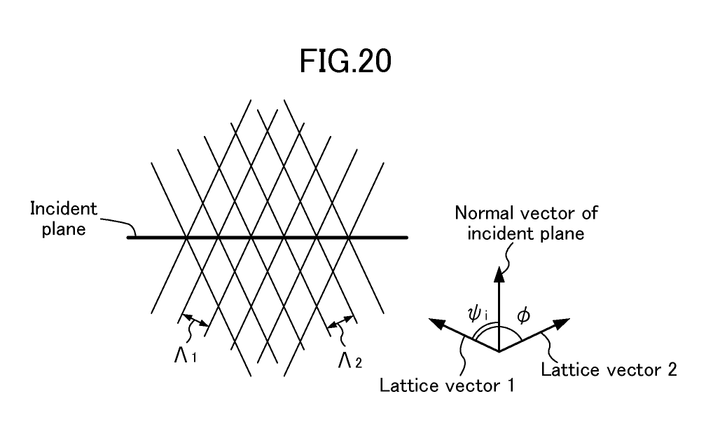

Next, derivation of data of FIG. 18 and FIG. 19 will be described with reference to FIG. 20.

FIG. 20 shows the relationship between the angle between the lattice vector 1 and the normal vector of the incident plane and the angle between the lattice vector 2 and incident plane.

In this case, the angle between the lattice vector 1 and the lattice vector 2 (which is at a side of an incident plane where a normal vector exits) is indicated by φ. Cycles of the lattice vectors 1 and 2 are Λ₁ and Λ₂, respectively.

The condition for diffraction light not to be generated in a two-dimensional structure is expressed by Formula (11) below.

$$\begin{matrix}[ Formula 11 ] & \\ \{ \begin{matrix}\frac{{Λ}_{1}}{λ} < \frac{1}{\sqrt{{[ sin {ϕ}_{i} ( {n}_{d} + {n}_{i} sin {θ}_{max} ) ]}^{2} + {[ {n}_{d} cos {ϕ}_{i} ]}^{2}}} \\ \frac{{Λ}_{2}}{λ} < \frac{1}{\sqrt{{[ sin ( ϕ - {ϕ}_{i} ) ( {n}_{d} + {n}_{i} sin {θ}_{max} ) ]}^{2} + {[ {n}_{d} cos ( ϕ - {ϕ}_{i} ) ]}^{2}}}\end{matrix} & ( 11 )\end{matrix}$$

In this case, when light enters the antireflection concave-convex structure 26 from air and an incident angle of the light is 0 degree to 90 degrees, n_{d}=nᵢ=1, θₘₐₓ=90 degrees. The condition for diffraction light (reflection diffraction light) not to be generated is expressed by Formula (12) below, based on Formula (8).

$$\begin{matrix}[ Formula 12 ] & \\ \{ \begin{matrix}\frac{{Λ}_{1}}{λ} < \frac{1}{\sqrt{1 + 3 {sin}^{2} {ϕ}_{i}}} \\ \frac{{Λ}_{2}}{λ} < \frac{1}{\sqrt{1 + 3 {sin}^{2} ( ϕ - {ϕ}_{i} )}}\end{matrix} & ( 12 )\end{matrix}$$

In this case, if φ=90° is assumed, Formula (9) can be transformed into Formula (13) below.

$$\begin{matrix}[ Formula 13 ] & \\ \{ \begin{matrix}\frac{{Λ}_{1}}{λ} < \frac{1}{\sqrt{1 + 3 {sin}^{2} {φ}_{i}}} \\ \frac{{Λ}_{2}}{λ} < \frac{1}{\sqrt{1 + 3 {cos}^{2} {φ}_{i}}}\end{matrix} & ( 13 )\end{matrix}$$

Data of FIG. 18 and FIG. 19 can be obtained, based on Formula (13).

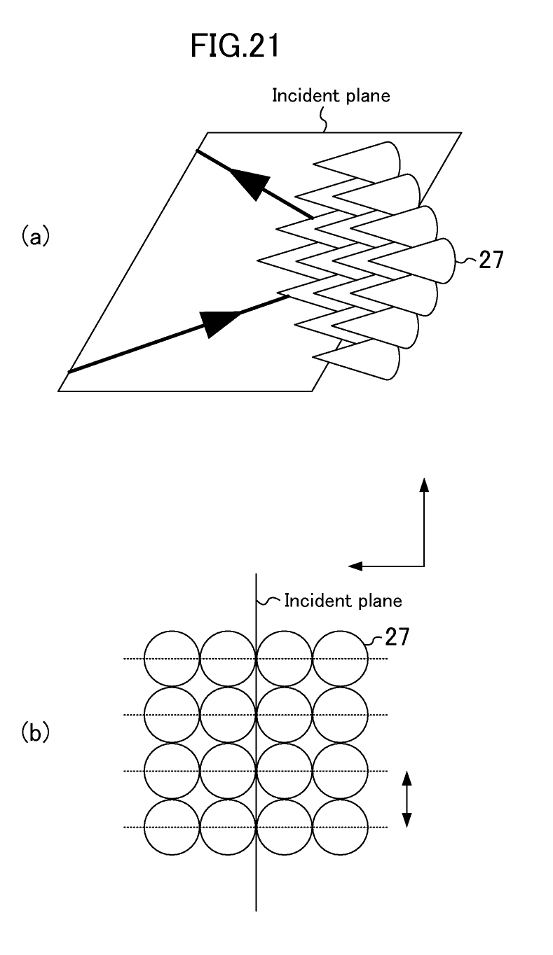

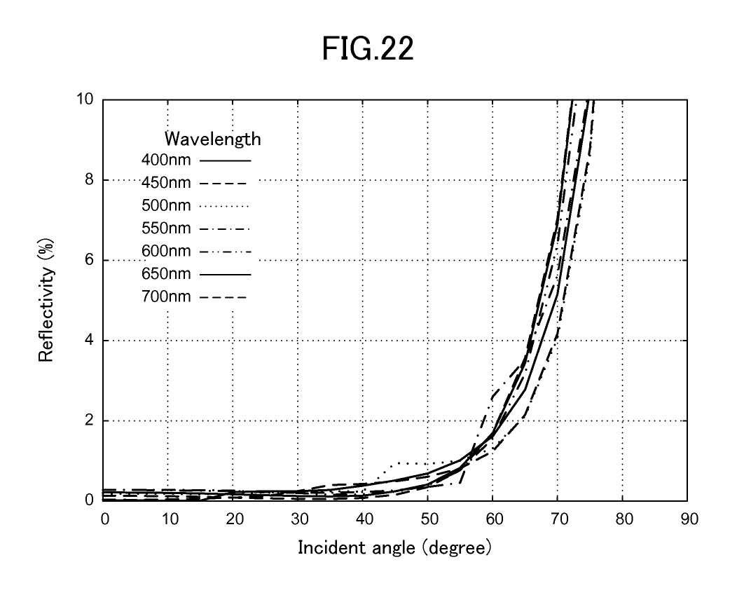

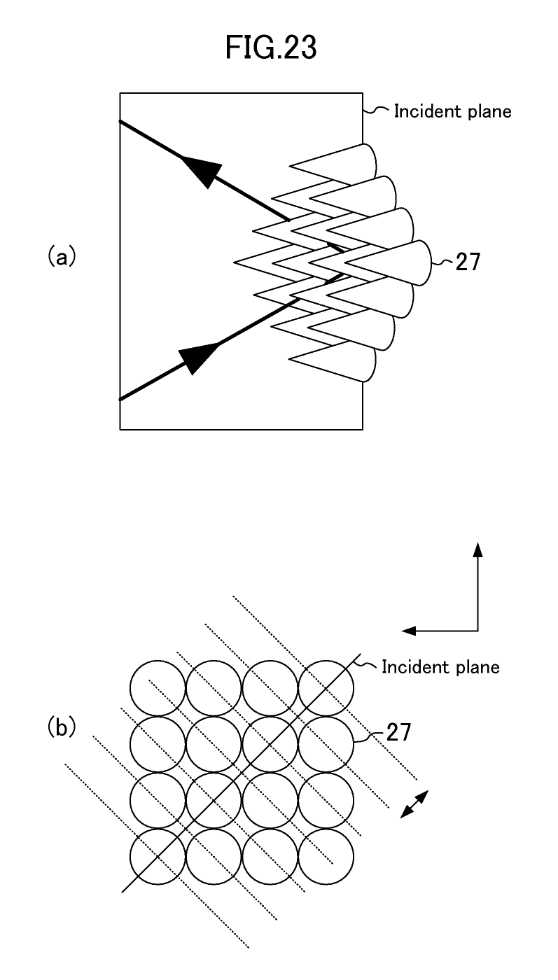

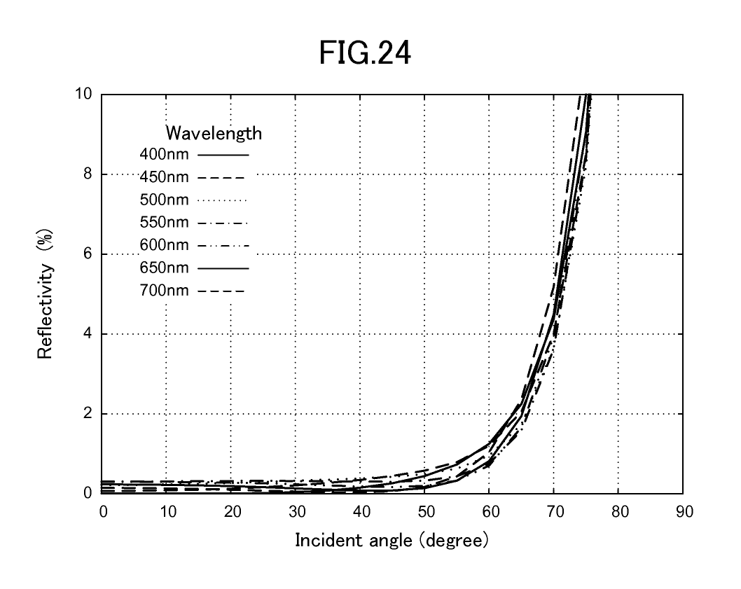

Note that FIG. 21(a) and FIG. 21(b) are schematic diagrams showing the relationship between the antireflection concave-convex structure 26 and an incident plane when a difference between ψᵢ(1) and ψᵢ(2) is 90 degrees. FIG. 22 is a graph (of simulation results) showing the correlation between incident angle and reflectivity when the difference between ψᵢ(1) and ψᵢ(2) is 90 degrees. FIG. 23(a) and FIG. 23(b) are schematic diagrams showing the relationship between the antireflection concave-convex structure 26 and an incident plane when ψᵢ(1)=ψᵢ(2)=45 degrees holds, i.e., the difference between ψᵢ(1) and ψᵢ(2) is 0 degree. FIG. 24 is a graph (of simulation results) showing the correlation between incident angle and reflectivity when ψᵢ(1)=ψᵢ(2)=45 degrees holds, i.e., the difference between ψᵢ(1) and ψᵢ(2) is 0 degree. Note that results of FIG. 22 and FIG. 24 were obtained when it was assumed that the antireflection concave-convex structure 26 was formed so that convex portions each having a conical shape with a height of 300 nm were arranged with a cycle 300 nm. In the simulation, it was also assumed that light entered the antireflection concave-convex structure 26 having a refractive index of 1.46 from a solvent having a refractive index of 1. For wavelength, a wavelength was plotted every 50 nm in a range from 400 nm to 700 nm. Light was non-polarized light.

When the difference between ψᵢ(1) and ψᵢ(2) is 90 degrees, as shown in FIG. 22, diffraction light is generated at a specific incident angle, and reflectivity is abruptly increased at the specific incident angle. For example, with light having a wavelength of 400 nm entering the antireflection concave-convex structure 26, reflected diffraction light is generated at an incident angle of 20 degrees, and reflectivity is increased to 3 times more as large as reflectivity of the case where reflected diffraction light is not generated.

When ψᵢ(1)=ψᵢ(2)=45 degrees holds, that is, the difference between ψᵢ(1) and ψᵢ(2) is 0 degree, diffraction light is not generated at an incident light of 0 degree to 90 degrees, and reflectivity is not abruptly increased at a specific incident angle.

Note that as in Embodiment 2, by adopting the antireflection concave-convex structure 26 formed of the cone convex portions 27 arranged in a two-dimensional manner, deflection dependency can be reduced, compared to the case where the antireflection concave-convex structure 15 formed of the filiform convex portions 16 arranged along one direction is adopted.

### Modified Example 1

In Embodiment 1, an example where the antireflection concave-convex structure 15 is formed of the plurality of filiform convex portions 16 arranged on the interior surface 1a of the lens tube 1 has been described. However, an antireflection concave-convex structure in which a plurality of conical convex portions satisfying the conditions described in Embodiment 2 are arranged may be formed on the interior surface 1a.

In Embodiment 1, an antireflection concave-convex structure 15 in which structure units such as filiform convex portions or cone convex portions described in Embodiment 1 or Embodiment 2 are arranged on a lens surface of each of the lenses 13a through 13c constituting the image formation optical system 13 may be formed. Thus, the generation of reflection light at the lens surface of each of the lenses 13a through 13c can be effectively suppressed.

### Embodiment 3

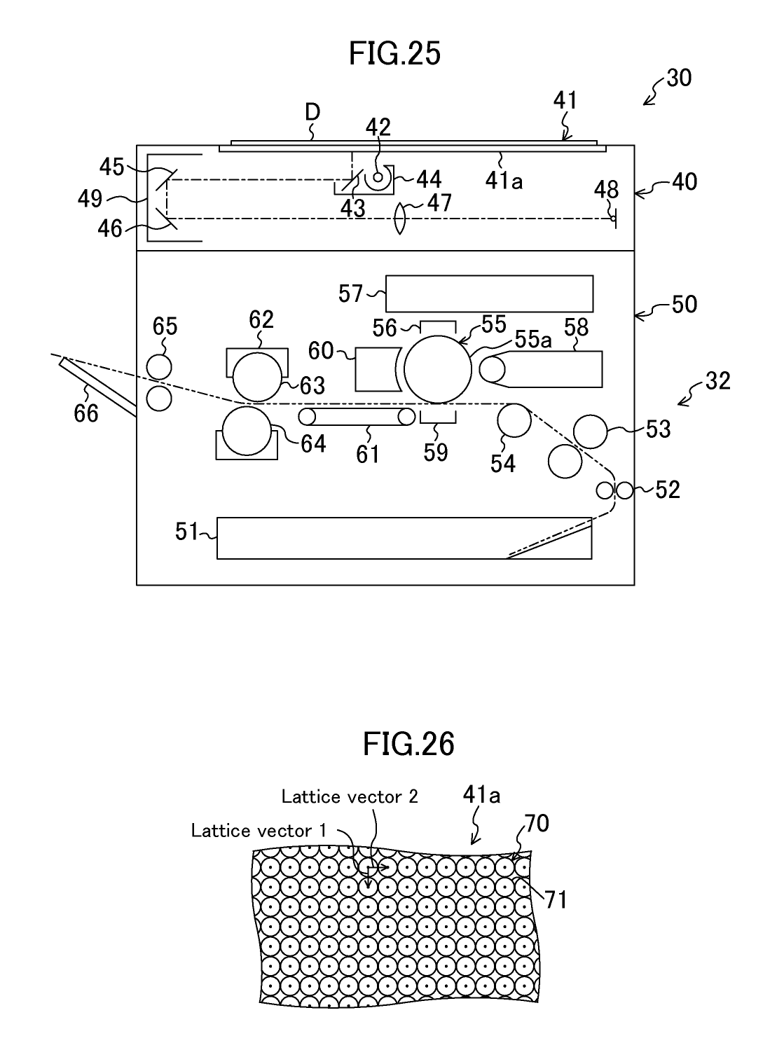

FIG. 25 is a diagram illustrating a configuration of major part of a copying machine 30 according to Embodiment 3 of the present invention.

FIG. 26 is a schematic plan view of a surface 41a of a platen glass 41.

The copying machine 30 of Embodiment 3 includes an image reading unit 40 and a body unit 50. The image reading unit 40 is provided to read an original set therein. The body unit 50 is provided to copy the original read by the image reading unit 40.

The image reading unit 40 includes a platen glass 41, a constant speed unit 44, a half speed unit 49, a lens 47 and an image sensor 48.

The constant speed unit 44 is configured so as to be capable of scanning in a scan direction (i.e., a lateral direction in FIG. 25). The constant speed unit 44 includes an exposure lamp 42 and a first mirror 43. The exposure lamp 42 is provided to expose an original placed on the platen glass 41 to light. The first mirror 43 is provided to reflect reflection light from the original toward the half speed unit 49.

The original placed on the platen glass 41 is scanned with the constant speed unit 44. Specifically, the original is scanned with the constant speed unit 44 while being exposed to light with the exposure lamp 42. Then, reflection light from the original from one end to the other end thereof is reflected in order toward the half speed unit 49.

The half speed unit 49 is provided to guide light from the first mirror 43 toward the image sensor 48 while moving in the same direction as that in which the constant speed unit 44 moves at a half speed of a moving speed of the constant speed unit 44.

Specifically, the half speed unit 49 includes a second mirror 45 and a third mirror 46. The second mirror 45 is provided to reflect light from the first mirror 43 toward the third mirror 46. The third mirror 46 is provided to reflect light from the second mirror 45 toward the image sensor 48.

The lens 47 is arranged between the half speed unit 49 and the image sensor 48. With the lens 47, light from the half speed unit 49 is focused on the image sensor 48. Thus, an optical image of the original is input to the image sensor 48 and the image sensor 48 converts the optical image to an electric signal. The converted electric signal is input to the body unit 50.

In the body unit 50, a paper cassette 51 in which a stack of paper is set is provided. In the paper cassette 51A, a pickup roller (not shown) is provided. The pickup roller is provided to pick up a topmost sheet of paper of the stack set in the paper cassette 51. Rollers 52 through 54 are provided anteriorly to the paper cassette 51 in a paper pickup direction. With the rollers 52 through 54, the sheet picked up by the pickup roller (not shown) is conveyed.

A photosensitive drum 55 in which a photoreceptor is applied to a surface 55a thereof is arranged, in part to which the sheet is conveyed, so as to be opposed to a surface of the sheet. The photosensitive drum 55 is configured so as to be pivotally supported about its axis extending along a width direction of the sheet and be rotatable according to a direction in which the sheet is conveyed.

In vicinity of the photosensitive drum 55, a charger 56, an optical scanning device 57, a developer 58, a transcriber 59 and a cleaning unit 60 are arranged in this order along a rotation direction of the photosensitive drum 55. The charger 56 is provided to uniformly charge the surface 55a of the photosensitive drum 55. The optical scanning device 57 is provided to perform exposure scanning on the charged surface 55a and thereby form an electrostatic latent image corresponding to an electric signal input from the image reading unit 40 on the surface 55a. The developer 58 is provided to form a toner image on the surface 55a by transferring toner to the formed electrostatic latent image. The transcriber 59 is provided to transcribe the formed toner image on the surface 55a to the sheet.

A handler belt 61 and a fuser unit 62 are arranged in part to which the sheet on which the toner image has been transcribed is conveyed. The handler belt 61 is provided to convey each sheet of paper on which a toner image has been transcribed to supply it to the fuser unit 62. The fuser unit 62 includes a fuser roller 63 and a press roller 64 which face to each other and each of which is pivotally supported about its axis extending along a width direction of the sheet so as to be rotatable. The press roller 64 is provided to press the sheet to the fuser roller 63. The fuser roller 63 is provided to heat the sheet and thereby fuse a toner image on the sheet.

A roller 65 for conveying the toner-fused sheet o a paper output tray 66 is provided anteriorly to the fuser unit 62.

As has been described, reading an original in the image reading unit 40 is performed by exposing an original to light through the platen glass 41 with the exposure lamp 42 and detecting reflection light thereof. However, for example, when light from exposure lamp 42 is reflected at the surface 41a of the platen glass 41 at the first mirror 43 side, stray light is generated and an intensity of light to be detected is reduced. Accordingly, image detection accuracy might be reduced.

However, in Embodiment 3, as shown in FIG. 26, an antireflection concave-convex structure 70 formed of a plurality of fine cone convex portions 71 regularly arranged is provided on the surface 41a of the platen glass 41 (specifically, at least part of the surface 41a into which light from the exposure lamp 42 comes). Specifically, the cone convex portions 71 are arranged (for example, in a square array or a triangular lattice) with a smaller pitch than a wavelength of light from the exposure lamp 42. Thus, reflection of light from the exposure lamp 42 at the surface 41a of the platen glass 41 can be effectively suppressed. Accordingly, high image detection accuracy of the image reading unit 40 and, furthermore, high copy accuracy of the copying machine 30 can be achieved.

Note that in Embodiment 3, as in Embodiment 2, as long as the antireflection concave-convex structure 70 has a shape which allows a moderate distribution of refractive index, the shape the antireflection concave-convex structure 70 is not particularly limited. For example, the antireflection concave-convex structure 70 may be formed of a plurality of cone concave portions. The antireflection concave-convex structure 70 may be also formed of a plurality of filiform convex portions or filiform concave portions.

The antireflection concave-convex structure 70 may be cyclic or non-cyclic.

A height of the cone convex portions 71 is preferably set to be 0.4 or more times as large as a wavelength of light emitted from the exposure lamp 42. Thus, reflection of light from the exposure lamp 42 at the surface 41a can be more effectively suppressed.

In Embodiment 3, as shown in FIG. 26, the antireflection concave-convex structure 70 is configured so that a difference between an angle ψᵢ(1) between a lattice vector 1 and a normal vector of an incident plane of light coming from the exposure lamp 42 and an angle ψᵢ(2) between a lattice vector 2 and the normal vector is 30 degrees or less. In other words, the platen glass 41 is arranged so that the difference between the angle ψᵢ(1) between the lattice vector 1 and the normal vector of the incident plane laser light and the angle ψᵢ(2) between the lattice vector 2 and the normal vector is 30 degrees or less. Thus, as has been described in Embodiment 2, the antireflection concave-convex structure 70 substantially allows prevention of the generation of diffraction light and also can be formed in a simple manner. Therefore, the copying machine 30 which has a high optical performance and also can be fabricated in a simple manner can be achieved.

The difference between the angle ψᵢ(1) and the angle ψᵢ(2) is more preferably 20 degrees or less, and it is even more preferably 10 degrees or less. It is the most preferable to set the angle ψᵢ(1) and the angle ψᵢ(2) so that a maximum pitch of the antireflection concave-convex structure 70, in which diffraction light is not substantially generated, along the lattice vector 1 and a maximum pitch of the antireflection concave-convex structure 70, in which diffraction light is not substantially generated, along the lattice vector 2 is approximately the same and the angle ψᵢ(1) and the angle ψᵢ(2) are approximately the same.

Note that the pitch of the antireflection concave-convex structure 70 along the lattice vector 1 and the pitch of the antireflection concave-convex structure 70 along the lattice vector 2 may be approximately the same or may be different as long as each of the pitches is set to be in the range which allows prevention of the generation of diffraction light.

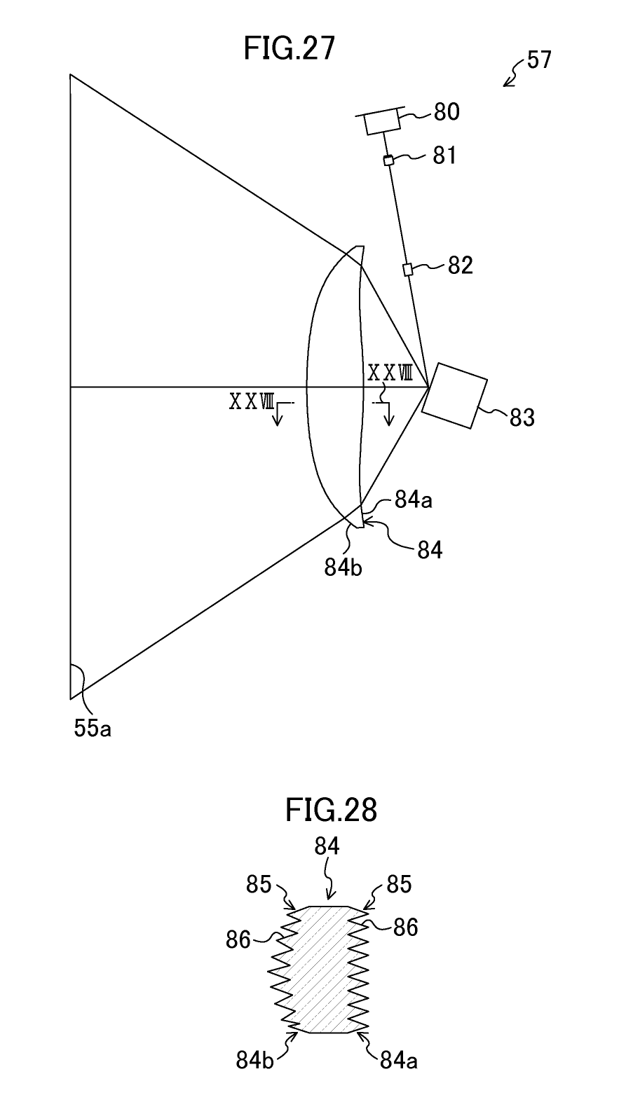

Next, a configuration of the optical scanning device 57 of Embodiment 3 will be described in detail with reference to FIG. 27 and FIG. 28.

FIG. 27 is a diagram illustrating a configuration of major part of a light scanning unit (LSU) 57.

FIG. 28 is a cross-sectional view of part cut out along a cut out line XXVIII-XXVIII of FIG. 27.

The optical scanning device 57 is provided to perform exposure scanning on the surface 55a (to which scanning is performed to) of the photosensitive drum 55 according to an electric signal input from the image reading unit 40 and thereby form an electrostatic latent image.

The optical scanning device 57 includes a light source 80 formed of a semiconductor laser or the like and a scanning optical system. The scanning optical system includes a first image formation optical system, a deflector 83 and a second image formation optical system.

The first image formation optical system is provided to form a light flux from the light source 80 into a line image on a polarization plane of the deflector 83. Specifically, in Embodiment 3, the first image formation optical system is formed of a collimator lens 81 and a cylindrical lens 82. The collimator lens 81 is provided to convert a light flux from the light source 80 into collimated light fluxes. The cylindrical lens 82 does not have optical power in a horizontal scanning direction but has (positive) optical power only in a vertical scanning direction and is provided to collect light from the collimator lens 81 in the vertical scanning direction and form a line image on the polarization plane of the deflector 83.

The deflector 83 is provided to reflect light from the first image formation optical system and thereby deflect the light in the horizontal scanning direction. The deflector 83 can be formed of, for example, a polygon mirror which has a plurality of deflection surfaces and is pivotally supported about its axis so as to be rotatable.

A light flux deflected by the deflector 83 is formed into an image on the surface 55a of the photosensitive drum 55, which is a target surface to be scanned, with the second image formation optical system. The second image formation optical system can be formed of, for example, an fθ lens 84. The fθ lens 84 is preferably, for example, an anamorphic lens having different optical powers in a horizontal scanning direction and in a vertical scanning direction, respectively.

In this case, as shown in FIG. 28, antireflection concave-convex structures 85 are formed on a surface 84a of the fθ lens 84 located at a light source 80 side and a surface 84b of the fθ lens 84 located at a photosensitive drum 55 side, respectively. Each of the antireflection concave-convex structure 85 is formed of a plurality of fine filiform convex portions 86 which extend in parallel to one another in one direction and are regularly arranged. Specifically, the filiform convex portions 86 are arranged with a pitch equal to or smaller than a wavelength of a light flux from the light source 80. Thus, reflection of a light flux from the light source 80 at the surfaces 84a and 84b of the fθ lens 84 can be effectively suppressed. Therefore, the generation of stray light and an optical intensity loss can be suppressed and a high optical performance can be achieved.

Note that as long as a pitch of the antireflection concave-convex structures 85 is equal to or smaller than a wavelength of light from the light source 80, the pitch of the antireflection concave-convex structures 85 may be approximately constant (i.e., cyclic) throughout each of the surfaces 84a and 84b. Also, the pitch of the antireflection concave-convex structures 85 may vary among different parts on each of the surfaces 84a and 84b. That is, each of the antireflection concave-convex structures 85 may be non-cyclic. With each of the antireflection concave-convex structures 85 formed so as to be non-cyclic, the generation of diffraction light can be effectively suppressed.

As long as each of the filiform convex portions 86 has a shape which allows a moderate distribution of refractive index at each of the surfaces 84a and 84b, the shape of each of the filiform convex portions 86 is not particularly limited.

A height of the filiform convex portions 86 is preferably set to be 0.4 times or more as large as the longest wavelength in a wavelength band of light from the light source 80. Thus, the generation of reflection light at each of the surfaces 84a and 84b can be more effectively suppressed.

In Embodiment 3, each of the antireflection concave-convex structures 85 is formed so that an angle ψᵢ between a normal vector of an incident plane of light entering the antireflection concave-convex structure 85 and a vector (lattice vector) connecting respective apex portions of adjacent two of the filiform convex portions 86 at the incident plane is 60 degrees or less. In other words, the fθ lens 84 is arranged so that an angle ψᵢ between the normal vector of the incident plane of light coming into the antireflection concave-convex structure 85 and the lattice vector is 60 degrees or less. Thus, as has been described in Embodiment 1, each of the antireflection concave-convex structures 85 substantially allows prevention of the generation of diffraction light and also can be formed in a simple manner. Therefore, the copying machine 30 which has a high optical performance and also can be fabricated in a simple manner can be achieved. Note that the angle ψᵢ is more preferably in a range of 45 degrees or less. Furthermore, the angle ψᵢ is even more preferably 15 degrees or less. Particularly, it is preferable that angle ψᵢ is substantially 0.

As has been described, in Embodiment 3, an optical device having a light source implemented according to the present disclosure has been described using a copying machine as an example. However, such optical device having a light source implemented according to the present disclosure is not limited to a copying machine. For example, an optical device according to the present disclosure may be an illuminating device (sheet illuminating device), a display device, a projector and the like. An optical member according to an embodiment of the present invention may be a so-called black body member, a lens, a prism, a deflecting plate, a phase correction device or the like, which absorbs light.

### INDUSTRIAL APPLICABILITY

In an optical member according to the present disclosure, the generation of reflection light and diffraction light is suppressed, and thus such optical member is useful as an optical device represented by an antireflection plate lens tube, a lens or the like. Also, an optical member according to the present disclosure is useful for various optical systems including an image formation optical system, an object optical system, a scanning optical system and the like, optical units including a lens tube unit, an optical pickup unit and the like, an imaging device, an optical pickup device, an optical scanning device, and the like.

1. An optical member in which an antireflection concave-convex structure for suppressing reflection of light, formed of a plurality of fine structure units of filiform convex portions or filiform concave portions regularly arranged, is provided on its surface,
wherein the antireflection concave-convex structure is configured so that an angle between a normal vector of an incident plane of the light whose reflection is to be suppressed and a vector connecting respective apexes of adjacent two of the structure units at the incident plane is 60 degrees or less.

2. An optical member in which an antireflection concave-convex structure for suppressing reflection of light, formed of a plurality of fine structure units of filiform convex portions or filiform concave portions regularly arranged, is provided on its surface,
wherein the optical member is arranged for use so that an angle between a normal vector of an incident plane of the light whose reflection is to be suppressed and a vector connecting respective apexes of adjacent two of the structure units at the incident plane is 60 degrees or less.

3. An optical member in which an antireflection concave-convex structure for suppressing reflection of light, formed of a plurality of fine structure units of cone convex portions or cone concave portions regularly arranged, is provided on its surface,
wherein the antireflection concave-convex structure is configured so that a difference between an angle between a normal vector of an incident plane of the light whose reflection is to be suppressed and one of two vectors one of which connects an apex of one of the structure units to an apex of one adjacent structure unit and the other of which connects the apex of the one structure unit to an apex of another adjacent structure unit and an angle between the normal vector and the other one of the two vectors is 30 degrees or less.

4. An optical member in which an antireflection concave-convex structure for suppressing reflection of light, formed of a plurality of fine structure units of cone convex portions or cone concave portions regularly arranged, is provided on its surface,
wherein the optical member is arranged for use so that a difference between an angle between a normal vector of an incident plane of the light whose reflection is to be suppressed and one of two vectors one of which connects an apex of one of the structure units to an apex of one adjacent structure unit and the other of which connects the apex of the one structure unit to an apex of another adjacent structure unit and an angle between the normal vector and the other one of the two vectors is 30 degrees or less.

5. The optical member of claim 1, wherein the optical member is used for an optical device having a light source and the light whose reflection is to be suppressed is emitted from the light source.

6. The optical member of claim 1, wherein the optical member is used in the presence of a light source and the light whose reflection is to be suppressed is emitted from the light source.

7. The optical member of claim 3, wherein the structure units are arranged in a square array.

8. The optical member of claim 3, wherein the structure units are arranged in a triangular lattice.

9. The optical member of claim 3, wherein a pitch of the structure units in one direction along which one of the two vectors extends differs from a pitch of the structure units in the other direction along which the other of the two vectors extends.

10. The optical member of claim 1, wherein the optical member absorbs the light whose reflection is to be suppressed.

11. The optical member of claim 1, wherein the optical member is an optical element.

12. The optical member of claim 1, wherein the optical member has a cylindrical shape and the antireflection concave-convex structure is provided on an interior surface of the optical member.

13. An optical system comprising the optical member of claim 11.

14. An optical unit comprising the optical system of claim 13.

15. An optical unit comprising:
an optical unit; and
an optical member in which an antireflection concave-convex structure formed of a plurality of fine structure units of filiform convex portions or filiform concave portions regularly arranged is provided on its surface and which is arranged so that light coming from the optical system enters the surface,
wherein the optical member is arranged so that an angle between a normal vector of an incident plane of the light coming from the optical system and a vector connecting respective apexes of adjacent two of the structure units is 60 degrees or less.

16. An optical unit comprising:
an optical unit; and
an optical member in which an antireflection concave-convex structure formed of a plurality of fine structure units of cone convex portions or cone concave portions regularly arranged is provided on its surface and which is arranged so that light coming from the optical system enters the surface,
wherein the optical member is arranged so that a difference between an angle between a normal vector of an incident plane of the light coming from the optical system and one of two vectors one of which connects an apex of one of the structure units to an apex of one adjacent structure unit and the other of which connects the apex of the one structure unit to an apex of another adjacent structure unit and an angle between the normal vector and the other one of the two vectors is 30 degrees or less.

17. An optical device comprising the optical unit of 16 claim 14.

18. The optical device of claim 17, wherein the optical system is an image formation optical system and the optical device further includes a detector, located on the incident plane, for detecting an optical image formed by the optical system.

19. The optical device of claim 17, further comprising a light source for emitting light to the optical system.
